(19) United States
(12) Patent Application Publication
(10) Pub. No.: US 2022/0122619 A1
(43) Pub. Date: Apr. 21, 2022

(54) Stereo Encoding Method and Apparatus, and Stereo Decoding Method and Apparatus

(71) Applicant: Huawei Technologies Co., Ltd., Shenzhen (CN)

(72) Inventors: Eyal Shlomot, Long Beach, CA (US); Yuan Gao, Beijing (CN); Bin Wang, Shenzhen (CN)

(21) Appl. No.: 17/563,538

(22) Filed: Dec. 28, 2021

Related U.S. Application Data
(63) Continuation of application No. PCT/CN2020/096296, filed on Jun. 16, 2020.

(30) Foreign Application Priority Data
Jun. 29, 2019 (CN) 201910581398.5

(51) Int. Cl. G10L 19/02; G10L 19/008; H04S 7/00; H04S 1/00

(52) U.S. Cl. CPC G10L 19/02; G10L 19/008; H04S 2400/03; H04S 1/002; H04S 7/30

(57) ABSTRACT

A stereo encoding method includes: performing downmix processing on a left channel signal of a current frame and a right channel signal of the current frame to obtain a primary channel signal of the current frame and a secondary channel signal of the current frame; and when determining to perform differential encoding on a pitch period of the secondary channel signal, performing differential encoding on the pitch period of the secondary channel signal using an estimated pitch period value of the primary channel signal to obtain a pitch period index value of the secondary channel signal, where the pitch period index value of the secondary channel signal is used to generate a to-be-sent stereo encoded bitstream.

### CROSS-REFERENCE TO RELATED APPLICATIONS

This application is a continuation of International Patent Application No. PCT/CN2020/096296 filed on Jun. 16, 2020, which claims priority to Chinese Patent Application No. 201910581398.5 filed on Jun. 29, 2019. The disclosures of the aforementioned applications are hereby incorporated by reference in their entireties.

### TECHNICAL FIELD

This application relates to the field of stereo technologies, and in particular, to a stereo encoding method and apparatus, and a stereo decoding method and apparatus.

### BACKGROUND

At present, mono audio cannot meet people's demand for high quality audio. Compared with mono audio, stereo audio has a sense of orientation and a sense of distribution for various acoustic sources, and can improve clarity, intelligibility, and a sense of presence of information, and therefore is popular among people.

To better transmit a stereo signal on a limited bandwidth, the stereo signal usually needs to be encoded first, and then an encoding-processed bitstream is transmitted to a decoder side through a channel. The decoder side performs decoding processing based on the received bitstream to obtain a decoded stereo signal for playback.

There are many different methods for implementing the stereo encoding and decoding technology. For example, time-domain signals are downmixed into two mono signals on an encoder side. Generally, left and right channels are first downmixed into a primary channel signal and a secondary channel signal. Then, the primary channel signal and the secondary channel signal are encoded by using a mono encoding method. The primary channel signal is usually encoded with a relatively large quantity of bits, and the secondary channel signal is usually not encoded. During decoding, the primary channel signal and the secondary channel signal are usually, separately obtained through decoding based on a received bitstream, and then time-domain upmix processing is performed to obtain a decoded stereo signal.

For stereo signals, an important feature that distinguishes them from mono signals is that the sound has sound image information, which makes the sound have a stronger sense of space. In a stereo signal, accuracy of a secondary channel signal can better reflect a sense of space of the stereo signal, and accuracy of secondary channel recoding also plays an important role in stability of a stereo sound image.

In stereo encoding, a pitch period, as an important feature of human speech production, is an important parameter for encoding of primary and secondary channel signals. Accuracy of a prediction value of the pitch period parameter affects the whole stereo encoding quality. In stereo encoding in time domain or frequency domain, a stereo parameter, a primary channel signal, and a secondary channel signal can be obtained after an input signal is analyzed. In a case where an encoding rate is relatively low (for example, 24.4 kbps or lower), an encoder typically encodes only the primary channel signal and does not encode the secondary channel signal. For example, a pitch period of the primary channel signal is directly used as a pitch period of the secondary channel signal. Because the secondary channel signal undergoes no decoding, a sense of space of the decoded stereo signal is poor, and sound image stability is greatly affected by a difference between the pitch period parameter of the primary channel signal and an actual pitch period parameter of the secondary channel signal. Consequently, stereo encoding performance is reduced, and stereo decoding performance is reduced accordingly.

### SUMMARY

Embodiments of this application provide a stereo encoding method and apparatus, and a stereo decoding method and apparatus, to improve stereo encoding and decoding performance.

To resolve the foregoing technical problem, the embodiments of this application provide the following technical solutions.

According to a first aspect, an embodiment of this application provides a stereo encoding method, including: performing downmix processing on a left channel signal of a current frame and a right channel signal of the current frame, to obtain a primary channel signal of the current frame and a secondary channel signal of the current frame; and when determining to perform differential encoding on a pitch period of the secondary channel signal, performing differential encoding on the pitch period of the secondary channel signal by using an estimated pitch period value of the primary channel signal, to obtain a pitch period index value of the secondary channel signal, where the pitch period index value of the secondary channel signal is used to generate a to-be-sent stereo encoded bitstream.

In this embodiment of this application, downmix processing is first performed on the left channel signal of the current frame and the right channel signal of the current frame, to obtain the primary channel signal of the current frame and the secondary channel signal of the current frame; and when it is determined to perform differential encoding on the pitch period of the secondary channel signal, differential encoding is performed on the pitch period of the secondary channel signal by using the estimated pitch period value of the primary channel signal, to obtain the pitch period index value of the secondary channel signal, where the pitch period index value of the secondary channel signal is used to generate the to-be-sent stereo encoded bitstream. In this embodiment of this application, because differential encoding is performed on the pitch period of the secondary channel signal by using the estimated pitch period value of the primary channel signal, a small quantity of bit resources are required to be allocated to the pitch period of the secondary channel signal for differential encoding. Through differential encoding of the pitch period of the secondary channel signal, a sense of space and sound image stability of the stereo signal can be improved. In addition, in this embodiment of this application, a relatively small quantity of bit resources are used to perform differential encoding on the pitch period of the secondary channel signal. Therefore, saved bit resources may be used for other stereo encoding parameters, so that encoding efficiency of the secondary channel is improved, and finally overall stereo encoding quality is improved.

In a possible implementation, the determining whether to perform differential encoding on a pitch period of the secondary channel signal includes: encoding the primary channel signal of the current frame, to obtain the estimated pitch period value of the primary channel signal; performing open-loop pitch period analysis on the secondary channel signal of the current frame, to obtain an estimated open-loop pitch period value of the secondary channel signal; determining whether a difference between the estimated pitch period value of the primary channel signal and the estimated open-loop pitch period value of the secondary channel signal exceeds a preset secondary channel pitch period differential encoding threshold; and when the difference exceeds the secondary channel pitch period differential encoding threshold, determining to perform differential encoding on the pitch period of the secondary channel signal; or when the difference does not exceed the secondary channel pitch period differential encoding threshold, determining to skip performing differential encoding on the pitch period of the secondary channel signal.

In this embodiment of this application, encoding may be performed based on the primary channel signal, to obtain the estimated pitch period value of the primary channel signal. After the secondary channel signal of the current frame is obtained, open-loop pitch period analysis may be performed on the secondary channel signal, so as to obtain the estimated open-loop pitch period value of the secondary channel signal. After the estimated pitch period value of the primary channel signal and the estimated open-loop pitch period value of the secondary channel signal are obtained, the difference between the estimated pitch period value of the primary channel signal and the estimated open-loop pitch period value of the secondary channel signal may be calculated, and then it is determined whether the difference exceeds the preset secondary channel pitch period differential encoding threshold. The secondary channel pitch period differential encoding threshold may be preset, and may be flexibly configured with reference to a stereo encoding scenario. When the difference exceeds the secondary channel pitch period differential encoding threshold, it is determined to perform differential encoding, or when the difference does not exceed the secondary channel pitch period differential encoding threshold, it is determined not to perform differential encoding.

In a possible implementation, when it is determined to perform differential encoding on the pitch period of the secondary channel signal, the method further includes: configuring a secondary channel pitch period differential encoding flag in the current frame to a preset first value, where the stereo encoded bitstream carries the secondary channel pitch period differential encoding flag, and the first value is used to indicate to perform differential encoding on the pitch period of the secondary channel signal. An encoder side obtains the secondary channel pitch period differential encoding flag. A value of the secondary channel pitch period differential encoding flag may be configured based on whether to perform differential encoding on the pitch period of the secondary channel signal. The secondary channel pitch period differential encoding flag is used to indicate whether to perform differential encoding on the pitch period of the secondary channel signal. The secondary channel pitch period differential encoding flag may have a plurality of values. For example, the secondary channel pitch period differential encoding flag may be the preset first value or a second value. The following describes an example of a method for configuring the secondary channel pitch period differential encoding flag. When it is determined to perform differential encoding on the pitch period of the secondary channel signal, the secondary channel pitch period differential encoding flag is configured to the first value.

In a possible implementation, the method further includes: when determining to skip performing differential encoding on the pitch period of the secondary channel signal and skip reusing the estimated pitch period value of the primary channel signal as the pitch period of the secondary channel signal, separately encoding the pitch period of the secondary channel signal and a pitch period of the primary channel signal. When differential encoding is not performed on the pitch period of the secondary channel signal, and the estimated pitch period value of the primary channel signal is not reused as the pitch period of the secondary channel signal, a pitch period independent encoding method for the secondary channel may be used in this embodiment of this application, to encode the pitch period of the secondary channel signal, so that the pitch period of the secondary channel signal can be encoded.

In a possible implementation, the method further includes: when determining to skip performing differential encoding on the pitch period of the secondary channel signal and reuse the estimated pitch period value of the primary channel signal as the pitch period of the secondary channel signal, configuring a secondary channel signal pitch period reuse flag to a preset fourth value; and using the stereo encoded bitstream to carry the secondary channel signal pitch period reuse flag, where the fourth value is used to indicate to reuse the estimated pitch period value of the primary channel signal as the pitch period of the secondary channel signal. When differential encoding is not performed on the pitch period of the secondary channel signal, a pitch period reusing method may be used in this embodiment of this application. To be specific, the encoder side does not encode the pitch period of the secondary channel, and the stereo encoded bitstream carries the secondary channel signal pitch period reuse flag. The secondary channel signal pitch period reuse flag is used to indicate whether the pitch period of the secondary channel signal reuses the estimated pitch period value of the primary channel signal. When the secondary channel signal pitch period reuse flag indicates that the pitch period of the secondary channel signal reuses the estimated pitch period value of the primary channel signal, a decoder side may use, based on the secondary channel signal pitch period reuse flag, the pitch period of the primary channel signal as the pitch period of the secondary channel signal for decoding.

In a possible implementation, the performing differential encoding on the pitch period of the secondary channel signal by using an estimated pitch period value of the primary channel signal, to obtain a pitch period index value of the secondary channel signal includes: performing secondary channel signal closed-loop pitch period search based on the estimated pitch period value of the primary channel signal, to obtain an estimated pitch period value of the secondary channel signal; determining an upper limit of the pitch period index value of the secondary channel signal based on a pitch period search range adjustment factor of the secondary channel signal; and calculating the pitch period index value of the secondary channel signal based on the estimated pitch period value of the primary channel signal, the estimated pitch period value of the secondary channel signal, and the upper limit of the pitch period index value of the secondary channel signal. The encoder side may perform secondary channel signal closed-loop pitch period search based on the estimated pitch period value of the secondary channel signal, to determine the estimated pitch period value of the secondary channel signal. The pitch period search range adjustment factor of the secondary channel signal may be used to adjust the pitch period index value of the secondary channel signal, to determine the upper limit of the pitch period index value of the secondary channel signal. The upper limit of the pitch period index value of the secondary channel signal indicates an upper limit value that the pitch period index value of the secondary channel signal cannot exceed. The pitch period index value of the secondary channel signal may be used to determine the pitch period index value of the secondary channel signal. After determining the estimated pitch period value of the primary channel signal, the estimated pitch period value of the secondary channel signal, and the upper limit of the pitch period index value of the secondary channel signal, the encoder side performs differential encoding based on the estimated pitch period value of the primary channel signal, the estimated pitch period value of the secondary channel signal, and the upper limit of the pitch period index value of the secondary channel signal, and outputs the pitch period index value of the secondary channel signal.

In a possible implementation, the performing secondary channel signal closed-loop pitch period search based on the estimated pitch period value of the primary channel signal, to obtain an estimated pitch period value of the secondary channel signal includes: determining a closed-loop pitch period reference value of the secondary channel signal based on the estimated pitch period value of the primary channel signal and a quantity of subframes into which the secondary channel signal of the current frame is divided; and performing closed-loop pitch period search by using integer precision and fractional precision and by using the closed-loop pitch period reference value of the secondary channel signal as a start point of the secondary channel signal closed-loop pitch period search, to obtain the estimated pitch period value of the secondary channel signal. The quantity of subframes into which the secondary channel signal of the current frame is divided may be determined based on a subframe configuration of the secondary channel signal. For example, the secondary channel signal may be divided into four subframes or three subframes, which is specifically determined with reference to an application scenario. After the estimated pitch period value of the primary channel signal is obtained, the estimated pitch period value of the primary channel signal and the quantity of subframes into which the secondary channel signal is divided may be used to calculate the closed-loop pitch period reference value of the secondary channel signal. The closed-loop pitch period reference value of the secondary channel signal is a reference value determined based on the estimated pitch period value of the primary channel signal. The closed-loop pitch period reference value of the secondary channel signal represents a closed-loop pitch period of the secondary channel signal that is determined by using the estimated pitch period value of the primary channel signal as a reference.

In a possible implementation, the determining a closed-loop pitch period reference value of the secondary channel signal based on the estimated pitch period value of the primary channel signal and a quantity of subframes into which the secondary channel signal of the current frame is divided includes: determining a closed-loop pitch period integer part loc_T0 of the secondary channel signal and a closed-loop pitch period fractional part loc_frac_prim of the secondary channel signal based on the estimated pitch period value of the primary channel signal; and calculating the closed-loop pitch period reference value f_pitch_prim of the secondary channel signal in the following manner: f_pitch_prim=loc_T0+loc_frac_prim/N; where N represents the quantity of subframes into which the secondary channel signal is divided. Specifically, the closed-loop pitch period integer part and the closed-loop pitch period fractional part of the secondary channel signal are first determined based on the estimated pitch period value of the primary channel signal. For example, an integer part of the estimated pitch period value of the primary channel signal is directly used as the closed-loop pitch period integer part of the secondary channel signal, and a fractional part of the estimated pitch period value of the primary channel signal is used as the closed-loop pitch period fractional part of the secondary channel signal. Alternatively, the estimated pitch period value of the primary channel signal may be mapped to the closed-loop pitch period integer part and the closed-loop pitch period fractional part of the secondary channel signal by using an interpolation method. For example, according to either of the foregoing methods, the closed-loop pitch period integer part loc_T0 and the closed-loop pitch period fractional part loc_frac_prim of the secondary channel may be obtained.

In a possible implementation, the determining an upper limit of the pitch period index value of the secondary channel signal based on a pitch period search range adjustment factor of the secondary channel signal includes: calculating the upper limit soft_reuse_index_high_limit of the pitch period index value of the secondary channel signal in the following manner: soft_reuse_index_high_limit=0.5+2^{Z}; where Z is the pitch period search range adjustment factor of the secondary channel signal.

In a possible implementation, a value of Z is 3, 4, or 5.

In a possible implementation, the calculating the pitch period index value of the secondary channel signal based on the estimated pitch period value of the primary channel signal, the estimated pitch period value of the secondary channel signal, and the upper limit of the pitch period index value of the secondary channel signal includes: determining a closed-loop pitch period integer part loc_T0 of the secondary channel signal and a closed-loop pitch period fractional part loc_frac_prim of the secondary channel signal based on the estimated pitch period value of the primary channel signal; and calculating the pitch period index value soft_reuse_index of the secondary channel signal in the following manner: soft_reuse_index=(N*pitch_soft_reuse+pitch_frac_soft_reuse)−(N*loc_T0+loc_frac_prim)+soft_reuse_index_high_limit/M; where pitch_soft_reuse represents an integer part of the estimated pitch period value of the secondary channel signal, pitch_frac_soft_reuse represents a fractional part of the estimated pitch period value of the secondary channel signal, soft_reuse_index_high_limit represents the upper limit of the pitch period index value of the secondary channel signal, N represents a quantity of subframes into which the secondary channel signal is divided, Nil represents an adjustment factor of the upper limit of the pitch period index value of the secondary channel signal, M is a non-zero real number, * represents a multiplication operator, + represents an addition operator, and − represents a subtraction operator.

In a possible implementation, the method is applied to a stereo encoding scenario in which an encoding rate of the current frame is lower than a preset rate threshold, where the rate threshold is at least one of the following values: 13.2 kilobits per second (kbps), 16.4 kbps, or 24.4 kbps. The rate threshold may be less than or equal to 13.2 kbps. For example, the rate threshold may alternatively be 16.4 kbps or 24.4 kbps. A specific value of the rate threshold may be determined based on an application scenario. When the encoding rate is relatively low (for example, 24.4 kbps or lower), independent encoding is not performed on the pitch period of the secondary channel, and the estimated pitch period value of the primary channel signal is used as a reference value. The differential encoding method is used to implement encoding of the pitch period of the secondary channel signal, to improve stereo encoding quality.

According to a second aspect, an embodiment of this application further provides a stereo decoding method, including: determining, based on a received stereo encoded bitstream, whether to perform differential decoding on a pitch period of a secondary channel signal; when determining to perform differential decoding on the pitch period of the secondary channel signal, obtaining, from the stereo encoded bitstream, an estimated pitch period value of a primary channel of a current frame and a pitch period index value of the secondary channel of the current frame; and performing differential decoding on the pitch period of the secondary channel signal based on the estimated pitch period value of the primary channel and the pitch period index value of the secondary channel, to obtain an estimated pitch period value of the secondary channel signal, where the estimated pitch period value of the secondary channel signal is used to decode the stereo encoded bitstream.

In this embodiment of this application, whether to perform differential decoding on the pitch period of the secondary channel signal is first determined based on the received stereo encoded bitstream; when it is determined to perform differential decoding on the pitch period of the secondary channel signal, the estimated pitch period value of the primary channel of the current frame and the pitch period index value of the secondary channel of the current frame are obtained from the stereo encoded bitstream; and differential decoding is performed on the pitch period of the secondary channel signal based on the estimated pitch period value of the primary channel and the pitch period index value of the secondary channel, to obtain the estimated pitch period value of the secondary channel signal, where the estimated pitch period value of the secondary channel signal is used to decode the stereo encoded bitstream. In this embodiment of this application, when differential decoding can be performed on the pitch period of the secondary channel signal, the estimated pitch period value of the primary channel signal and the pitch period index value of the secondary channel signal may be used to perform differential decoding on the pitch period of the secondary channel signal, to obtain the estimated pitch period value of the secondary channel signal, and the stereo encoded bitstream may be decoded by using the estimated pitch period value of the secondary channel signal. Therefore, a sense of space and sound image stability of the stereo signal can be improved.

In a possible implementation, the determining, based on a received stereo encoded bitstream, whether to perform differential decoding on a pitch period of a secondary channel signal includes: obtaining a secondary channel pitch period differential encoding flag from the current frame; and when the secondary channel pitch period differential encoding flag is a preset first value, determining to perform differential decoding on the pitch period of the secondary channel signal. In this embodiment of this application, the secondary channel pitch period differential encoding flag may have a plurality of values. For example, the secondary channel pitch period differential encoding flag may be a preset first value. For example, if a value of the secondary channel pitch period differential encoding flag is 1, differential decoding is performed on the pitch period of the secondary channel signal.

In a possible implementation, the method further includes: when determining to skip performing differential decoding on the pitch period of the secondary channel signal and skip reusing the estimated pitch period value of the primary channel signal as the pitch period of the secondary channel signal, decoding the pitch period of the secondary channel signal from the stereo encoded bitstream. When a decoder side determines not to perform differential decoding on the pitch period of the secondary channel signal, and not to reuse the estimated pitch period value of the primary channel signal as the pitch period of the secondary channel signal, a pitch period independent decoding method for the secondary channel may be used in this embodiment of this application, to decode the pitch period of the secondary channel signal, so that the pitch period of the secondary channel signal can be decoded.

In a possible implementation, the method further includes: when determining to skip performing differential decoding on the pitch period of the secondary channel signal and reuse the estimated pitch period value of the primary channel signal as the pitch period of the secondary channel signal, using the estimated pitch period value of the primary channel signal as the pitch period of the secondary channel signal. When the decoder side determines not to perform differential decoding on the pitch period of the secondary channel signal, a pitch period reusing method may be used in this embodiment of this application. For example, when the secondary channel signal pitch period reuse flag indicates that the pitch period of the secondary channel signal reuses the estimated pitch period value of the primary channel signal, the decoder side may perform decoding based on the secondary channel signal pitch period reuse flag by using the pitch period of the primary channel signal as the pitch period of the secondary channel signal.

In a possible implementation, the performing differential decoding on the pitch period of the secondary channel signal based on the estimated pitch period value of the primary channel and the pitch period index value of the secondary channel includes: determining a closed-loop pitch period reference value of the secondary channel signal based on the estimated pitch period value of the primary channel signal and a quantity of subframes into which the secondary channel signal of the current frame is divided; determining an upper limit of the pitch period index value of the secondary channel signal based on a pitch period search range adjustment factor of the secondary channel signal; and calculating the estimated pitch period value of the secondary channel signal based on the closed-loop pitch period reference value of the secondary channel signal, the pitch period index value of the secondary channel, and the upper limit of the pitch period index value of the secondary channel signal. Specifically, the closed-loop pitch period reference value of the secondary channel signal is determined by using the estimated pitch period value of the primary channel signal. For details, refer to the foregoing calculation process. The pitch period search range adjustment factor of the secondary channel signal may be used to adjust the pitch period index value of the secondary channel signal, to determine the upper limit of the pitch period index value of the secondary channel signal. The upper limit of the pitch period index value of the secondary channel signal indicates an upper limit value that the pitch period index value of the secondary channel signal cannot exceed. The pitch period index value of the secondary channel signal may be used to determine the pitch period index value of the secondary channel signal. After determining the closed-loop pitch period reference value of the secondary channel signal, the pitch period index value of the secondary channel signal, and the upper limit of the pitch period index value of the secondary channel signal, the decoder side performs differential decoding based on the closed-loop pitch period reference value of the secondary channel signal, the pitch period index value of the secondary channel signal, and the upper limit of the pitch period index value of the secondary channel signal, and outputs the estimated pitch period value of the secondary channel signal.

In a possible implementation, the calculating the estimated pitch period value of the secondary channel signal based on the closed-loop pitch period reference value of the secondary channel signal, the pitch period index value of the secondary channel signal, and the upper limit of the pitch period index value of the secondary channel signal includes: calculating the estimated pitch period value T0_pitch of the secondary channel signal in the following manner: T0_pitch=f_pitch_prim+(soft_reuse_index−soft_reuse_index_high_limit/M)/N, where f_pitch_prim represents the closed-loop pitch period reference value of the secondary channel signal, soft_reuse_index represents the pitch period index value of the secondary channel signal, N represents the quantity of subframes into which the secondary channel signal is divided, M represents an adjustment factor of the upper limit of the pitch period index value of the secondary channel signal, M is a non-zero real number, / represents a division operator, + represents an addition operator, and − represents a subtraction operator.

In a possible implementation, a value of the adjustment factor of the upper limit of the pitch period index value of the secondary channel signal is 2 or 3.

According to a third aspect, an embodiment of this application further provides a stereo encoding apparatus, including: a downmix module, configured to perform downmix processing on a left channel signal of a current frame and a right channel signal of the current frame, to obtain a primary channel signal of the current frame and a secondary channel signal of the current frame; and a differential encoding module, configured to: when it is determined to perform differential encoding on a pitch period of the secondary channel signal, perform differential encoding on the pitch period of the secondary channel signal by using an estimated pitch period value of the primary channel signal, to obtain a pitch period index value of the secondary channel signal, where the pitch period index value of the secondary channel signal is used to generate a to-be-sent stereo encoded bitstream.

In a possible implementation, the stereo encoding apparatus further includes: a primary, channel encoding module, configured to encode the primary channel signal of the current frame, to obtain the estimated pitch period value of the primary channel signal; an open-loop analysis module, configured to perform open-loop pitch period analysis on the secondary channel signal of the current frame, to obtain an estimated open-loop pitch period value of the secondary channel signal; and a threshold determining module, configured to: determine whether a difference between the estimated pitch period value of the primary channel signal and the estimated open-loop pitch period value of the secondary channel signal exceeds a preset secondary channel pitch period differential encoding threshold; and when the difference exceeds the secondary channel pitch period differential encoding threshold, determine to perform differential encoding on the pitch period of the secondary channel signal; or when the difference does not exceed the secondary channel pitch period differential encoding threshold, determine to skip performing differential encoding on the pitch period of the secondary channel signal.

In a possible implementation, the stereo encoding apparatus further includes a flag configuration module, configured to: when it is determined to perform differential encoding on the pitch period of the secondary channel signal, configure a secondary channel pitch period differential encoding flag in the current frame to a preset first value, where the stereo encoded bitstream carries the secondary channel pitch period differential encoding flag, and the first value is used to indicate to perform differential encoding on the pitch period of the secondary channel signal.

In a possible implementation, the stereo encoding apparatus further includes an independent encoding module, where the independent encoding module is configured to: when it is determined to skip performing differential encoding on the pitch period of the secondary channel signal and skip reusing the estimated pitch period value of the primary channel signal as the pitch period of the secondary channel signal, separately encode the pitch period of the secondary channel signal and a pitch period of the primary channel signal.

In a possible implementation, the stereo encoding apparatus further includes the flag configuration module, configured to: when it is determined to skip performing differential encoding on the pitch period of the secondary channel signal and reuse the estimated pitch period value of the primary channel signal as the pitch period of the secondary channel signal, configure a secondary channel signal pitch period reuse flag to a preset fourth value, and use the stereo encoded bitstream to carry the secondary channel signal pitch period reuse flag, where the fourth value is used to indicate to reuse the estimated pitch period value of the primary channel signal as the pitch period of the secondary channel signal.

In a possible implementation, the differential encoding module includes: a closed-loop pitch period search module, configured to perform secondary channel signal closed-loop pitch period search based on the estimated pitch period value of the primary channel signal, to obtain an estimated pitch period value of the secondary channel signal; an index value upper limit determining module, configured to determine an upper limit of the pitch period index value of the secondary channel signal based on a pitch period search range adjustment factor of the secondary channel signal; and an index value calculation module, configured to calculate the pitch period index value of the secondary channel signal based on the estimated pitch period value of the primary channel signal, the estimated pitch period value of the secondary channel signal, and the upper limit of the pitch period index value of the secondary channel signal.

In a possible implementation, the closed-loop pitch period search module is configured to: determine a closed-loop pitch period reference value of the secondary channel signal based on the estimated pitch period value of the primary channel signal and a quantity of subframes into which the secondary channel signal of the current frame is divided; and perform closed-loop pitch period search by using integer precision and fractional precision and by using the closed-loop pitch period reference value of the secondary channel signal as a start point of the secondary channel signal closed-loop pitch period search, to obtain the estimated pitch period value of the secondary channel signal.

In a possible implementation, the closed-loop pitch period search module is configured to: determine a closed-loop pitch period integer part loc_T0 of the secondary channel signal and a closed-loop pitch period fractional part loc_frac_prim of the secondary channel signal based on the estimated pitch period value of the primary channel signal; and calculate the closed-loop pitch period reference value f_pitch_prim of the secondary channel signal in the following manner: f_pitch_prim=loc_T0+loc_frac_prim/N; where N represents the quantity of subframes into which the secondary channel signal is divided.

In a possible implementation, the index value upper limit determining module is configured to calculate the upper limit soft_reuse_index_high_limit of the pitch period index value of the secondary channel signal in the following manner: soft_reuse_index_high_limit=0.5+2^{Z}; where Z is the pitch period search range adjustment factor of the secondary channel signal.

In a possible implementation, a value of Z is 3, 4, or 5.

In a possible implementation, the index value calculation module is configured to: determine a closed-loop pitch period integer part loc_T0 of the secondary channel signal and a closed-loop pitch period fractional part loc_frac_prim of the secondary channel signal based on the estimated pitch period value of the primary channel signal; and calculate the pitch period index value soft_reuse_index of the secondary channel signal in the following manner: soft_reuse_index=(N*pitch_soft_reuse+pitch_frac_soft_reuse)−(N*loc_T0+loc_frac_prim)+soft_reuse_index_high_limit/M; where pitch_soft_reuse represents an integer part of the estimated pitch period value of the secondary channel signal, pitch_frac_soft_reuse represents a fractional part of the estimated pitch period value of the secondary channel signal, soft_reuse_index_high_limit represents the upper limit of the pitch period index value of the secondary channel signal, N represents a quantity of subframes into which the secondary channel signal is divided, M represents an adjustment factor of the upper limit of the pitch period index value of the secondary channel signal, M is a non-zero real number, * represents a multiplication operator, represents an addition operator, and − represents a subtraction operator.

In a possible implementation, the stereo encoding apparatus is applied to a stereo encoding scenario in which an encoding rate of the current frame is lower than a preset rate threshold, where the rate threshold is at least one of the following values: 13.2 kbps, 16.4 kbps, or 24.4 kbps.

In the third aspect of this application, the composition modules of the stereo encoding apparatus may further perform steps described in the first aspect and the possible implementations. For details, refer to the foregoing descriptions in the first aspect and the possible implementations.

According to a fourth aspect, an embodiment of this application further provides a stereo decoding apparatus, including: a determining module, configured to determine, based on a received stereo encoded bitstream, whether to perform differential decoding on a pitch period of a secondary channel signal; a value obtaining module, configured to: when it is determined to perform differential decoding on the pitch period of the secondary channel signal, obtain, from the stereo encoded bitstream, an estimated pitch period value of a primary channel of a current frame and a pitch period index value of the secondary channel of the current frame; and a differential decoding module, configured to perform differential decoding on the pitch period of the secondary channel signal based on the estimated pitch period value of the primary channel and the pitch period index value of the secondary channel, to obtain an estimated pitch period value of the secondary channel signal, where the estimated pitch period value of the secondary channel signal is used to decode the stereo encoded bitstream.

In a possible implementation, the determining module is configured to: obtain a secondary channel pitch period differential encoding flag from the current frame; and when the secondary channel pitch period differential encoding flag is a preset first value, determine to perform differential decoding on the pitch period of the secondary channel signal.

In a possible implementation, the stereo decoding apparatus further includes an independent decoding module, where the independent decoding module is configured to: when it is determined to skip performing differential decoding on the pitch period of the secondary channel signal and skip reusing the estimated pitch period value of the primary channel signal as the pitch period of the secondary channel signal, decode the pitch period of the secondary channel signal from the stereo encoded bitstream.

In a possible implementation, the stereo decoding apparatus further includes a pitch period reusing module, where the pitch period reusing module is configured to: when it is determined to skip performing differential decoding on the pitch period of the secondary channel signal and reuse the estimated pitch period value of the primary channel signal as the pitch period of the secondary channel signal, use the estimated pitch period value of the primary channel signal as the pitch period of the secondary channel signal.

In a possible implementation, the differential decoding module includes: a reference value determining submodule, configured to determine a closed-loop pitch period reference value of the secondary channel signal based on the estimated pitch period value of the primary channel signal and a quantity of subframes into which the secondary channel signal of the current frame is divided; an index value upper limit determining submodule, configured to determine an upper limit of the pitch period index value of the secondary channel signal based on a pitch period search range adjustment factor of the secondary channel signal; and an estimated value calculation submodule, configured to calculate the estimated pitch period value of the secondary channel signal based on the closed-loop pitch period reference value of the secondary channel signal, the pitch period index value of the secondary channel, and the upper limit of the pitch period index value of the secondary channel signal.

In a possible implementation, the estimated value calculation submodule is configured to calculate the estimated pitch period value T0_pitch of the secondary channel signal in the following manner:

T0_pitch=f_pitch_prim+(soft_reuse_index−soft_reuse_index_high_limit/M)/N;

where f_pitch_prim represents the closed-loop pitch period reference value of the secondary channel signal, soft_reuse_index represents the pitch period index value of the secondary channel signal N represents the quantity of subframes into which the secondary channel signal is divided, M represents an adjustment factor of the upper limit of the pitch period index value of the secondary channel signal, M is a non-zero real number, / represents a division operator, + represents an addition operator, and − represents a subtraction operator.

In a possible implementation, a value of the adjustment factor of the upper limit of the pitch period index value of the secondary channel signal is 2 or 3.

In the fourth aspect of this application, the composition modules of the stereo decoding apparatus may further perform steps described in the second aspect and the possible implementations. For details, refer to the foregoing descriptions in the second aspect and the possible implementations.

According to a fifth aspect, an embodiment of this application provides a stereo processing apparatus. The stereo processing apparatus may include an entity such as a stereo encoding apparatus, a stereo decoding apparatus, or a chip, and the stereo processing apparatus includes a processor. Optionally, the stereo processing apparatus may further include a memory. The memory is configured to store instructions; and the processor is configured to execute the instructions in the memory, so that the stereo processing apparatus performs the method according to the first aspect or the second aspect.

According to a sixth aspect, an embodiment of this application provides a computer-readable storage medium. The computer-readable storage medium stores instructions, and when the instructions are run on a computer, the computer is enabled to perform the method according to the first aspect or the second aspect.

According to a seventh aspect, an embodiment of this application provides a computer program product including instructions. When the computer program product runs on a computer, the computer is enabled to perform the method according to the first aspect or the second aspect.

According to an eighth aspect, this application provides a chip system. The chip system includes a processor, configured to support a stereo encoding apparatus or a stereo decoding apparatus in implementing functions in the foregoing aspects, for example, sending or processing data and/or information in the foregoing methods. In a possible design, the chip system further includes a memory and the memory is configured to store program instructions and data that are necessary for the stereo encoding apparatus or the stereo decoding apparatus. The chip system may include a chip, or may include a chip and another discrete device.

### BRIEF DESCRIPTION OF DRAWINGS

FIG. 1 is a schematic diagram of a composition structure of a stereo processing system according to an embodiment of this application;

FIG. 2A is a schematic diagram of application of a stereo encoder and a stereo decoder to a terminal device according to an embodiment of this application;

FIG. 2B is a schematic diagram of application of a stereo encoder to a wireless device or a core network device according to an embodiment of this application;

FIG. 2C is a schematic diagram of application of a stereo decoder to a wireless device or a core network device according to an embodiment of this application;

FIG. 3A is a schematic diagram of application of a multi-channel encoder and a multi-channel decoder to a terminal device according to an embodiment of this application;

FIG. 3B is a schematic diagram of application of a multi-channel encoder to a wireless device or a core network device according to an embodiment of this application;

FIG. 3C is a schematic diagram of application of a multi-channel decoder to a wireless device or a core network device according to an embodiment of this application;

FIG. 4 is a schematic flowchart of interaction between a stereo encoding apparatus and a stereo decoding apparatus according to an embodiment of this application;

FIG. 5A and FIG. 5B are a schematic flowchart of stereo signal encoding according to an embodiment of this application;

FIG. 6 is a flowchart of encoding a pitch period parameter of a primary channel signal and a pitch period parameter of a secondary channel signal according to an embodiment of this application;

FIG. 7 is a diagram of comparison between a pitch period quantization result obtained by using an independent encoding scheme and a pitch period quantization result obtained by using a differential encoding scheme;

FIG. 8 is a diagram of comparison between a quantity of bits allocated to a fixed codebook after an independent encoding scheme is used and a quantity of bits allocated to a fixed codebook after a differential encoding scheme is used;

FIG. 9 is a schematic diagram of a time-domain stereo encoding method according to an embodiment of this application;

FIG. 10 is a schematic diagram of a composition structure of a stereo encoding apparatus according to an embodiment of this application;

FIG. 11 is a schematic diagram of a composition structure of a stereo decoding apparatus according to an embodiment of this application;

FIG. 12 is a schematic diagram of a composition structure of another stereo encoding apparatus according to an embodiment of this application; and

FIG. 13 is a schematic diagram of a composition structure of another stereo decoding apparatus according to an embodiment of this application.

### DESCRIPTION OF EMBODIMENTS

The embodiments of this application provide a stereo encoding method and apparatus, and a stereo decoding method and apparatus, to improve stereo encoding and decoding performance.

The following describes the embodiments of this application with reference to accompanying drawings.

In the specification, claims, and the accompanying drawings of this application, the terms “first”, “second”, and the like are intended to distinguish similar objects but do not necessarily indicate a specific order or sequence. It should be understood that the terms used in such a way are interchangeable in proper circumstances. This is merely a distinguishing manner that is used when objects having a same attribute are described in the embodiments of this application. In addition, the terms “include”, “have”, and any other variants thereof are intended to cover the non-exclusive inclusion, so that a process, method, system, product, or device that includes a series of units is not necessarily limited to those units, but may include other units not expressly listed or inherent to such a process, method, product, or device.

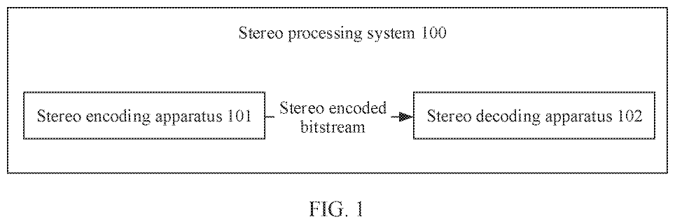

The technical solutions in the embodiments of this application may be applied to various stereo processing systems. FIG. 1 is a schematic diagram of a composition structure of a stereo processing system according to an embodiment of this application. The stereo processing system 100 may include a stereo encoding apparatus 101 and a stereo decoding apparatus 102. The stereo encoding apparatus 101 may be configured to generate a stereo encoded bitstream, and then the stereo encoded bitstream may be transmitted to the stereo decoding apparatus 102 through an audio transmission channel. The stereo decoding apparatus 102 may receive the stereo encoded bitstream, and then execute a stereo decoding function of the stereo decoding apparatus 102, to finally obtain a stereo decoded bitstream.

In this embodiment of this application, the stereo encoding apparatus may be applied to various terminal devices that have an audio communication requirement, and a wireless device and a core network device that have a transcoding requirement. For example, the stereo encoding apparatus may be a stereo encoder of the foregoing terminal device, wireless device, or core network device. Similarly, the stereo decoding apparatus may be applied to various terminal devices that have an audio communication requirement, and a wireless device and a core network device that have a transcoding requirement. For example, the stereo decoding apparatus may be a stereo decoder of the foregoing terminal device, wireless device, or core network device.

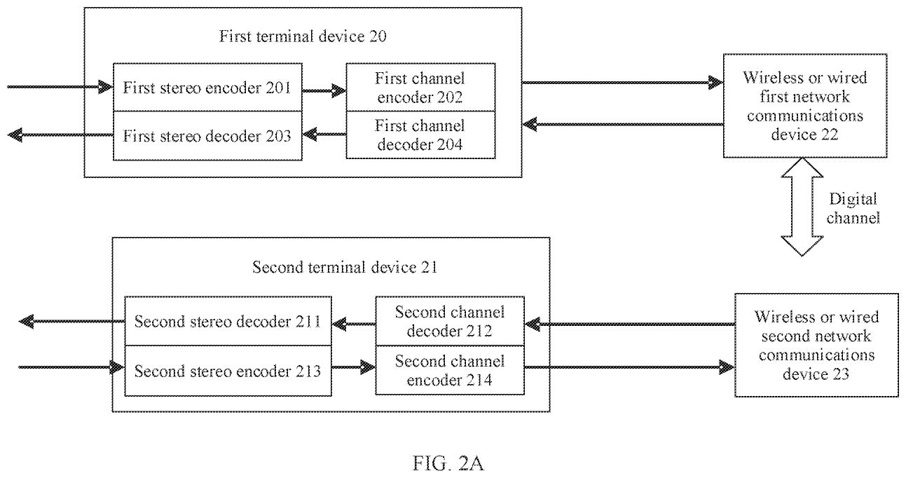

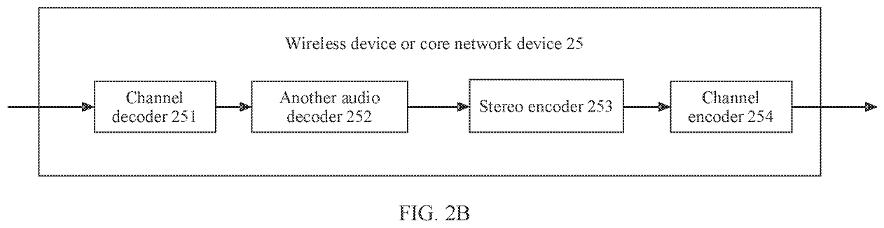

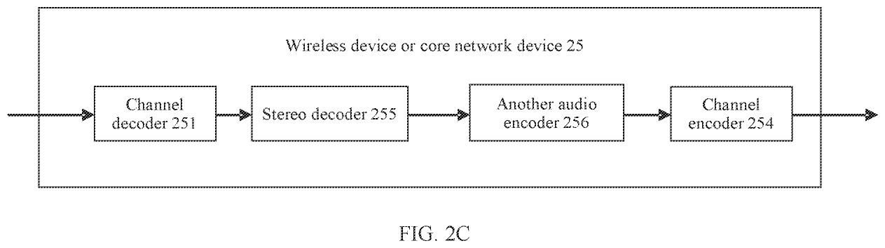

FIG. 2A is a schematic diagram of application of a stereo encoder and a stereo decoder to a terminal device according to an embodiment of this application. Each terminal device may include a stereo encoder, a channel encoder, a stereo decoder, and a channel decoder. Specifically, the channel encoder is used to perform channel encoding on a stereo signal, and the channel decoder is used to perform channel decoding on a stereo signal. For example, a first terminal device 20 may include a first stereo encoder 201, a first channel encoder 202, a first stereo decoder 203, and a first channel decoder 204. A second terminal device 21 may include a second stereo decoder 211, a second channel decoder 212, a second stereo encoder 213, and a second channel encoder 214. The first terminal device 20 is connected to a wireless or wired first network communications device 22, the first network communications device 22 is connected to a wireless or wired second network communications device 23 through a digital channel, and the second terminal device 21 is connected to the wireless or wired second network communications device 23. The foregoing wireless or wired network communications device may generally refer to a signal transmission device, for example, a communications base station or a data exchange device.

In audio communication, a terminal device serving as a transmit end performs stereo encoding on a collected stereo signal, then performs channel encoding, and transmits the stereo signal on a digital channel by using a wireless network or a core network. A terminal device serving as a receive end performs channel decoding based on a received signal to obtain a stereo signal encoded bitstream, and then restores a stereo signal through stereo decoding, and the terminal device serving as the receive end performs playback.

FIG. 2B is a schematic diagram of application of a stereo encoder to a wireless device or a core network device according to an embodiment of this application. The wireless device or core network device 25 includes: a channel decoder 251, another audio decoder 252, a stereo encoder 253, and a channel encoder 254. The another audio decoder 252 is an audio decoder other than a stereo decoder. In the wireless device or core network device 25, a signal entering the device is first channel-decoded by the channel decoder 251, then audio decoding (other than stereo decoding) is performed by the another audio decoder 252, and then stereo encoding is performed by using the stereo encoder 253. Finally, the stereo signal is channel-encoded by using the channel encoder 254, and then transmitted after the channel encoding is completed.

FIG. 2C is a schematic diagram of application of a stereo decoder to a wireless device or a core network device according to an embodiment of this application. The wireless device or core network device 25 includes: a channel decoder 251, a stereo decoder 255, another audio encoder 256, and a channel encoder 254. The another audio encoder 256 is an audio encoder other than a stereo encoder. In the wireless device or core network device 25, a signal entering the device is first channel-decoded by the channel decoder 251, then a received stereo encoded bitstream is decoded by using the stereo decoder 255, and then audio encoding (other than stereo encoding) is performed by using the another audio encoder 256. Finally, the stereo signal is channel-encoded by using the channel encoder 254, and then transmitted after the channel encoding is completed. In a wireless device or a core network device, if transcoding needs to be implemented, corresponding stereo encoding and decoding processing needs to be performed. The wireless device is a radio frequency-related device in communication, and the core network device is a core network-related device in communication.

In some embodiments of this application, the stereo encoding apparatus may be applied to various terminal devices that have an audio communication requirement, and a wireless device and a core network device that have a transcoding requirement. For example, the stereo encoding apparatus may be a multi-channel encoder of the foregoing terminal device, wireless device, or core network device. Similarly, the stereo decoding apparatus may be applied to various terminal devices that have an audio communication requirement, and a wireless device and a core network device that have a transcoding requirement. For example, the stereo decoding apparatus may be a multi-channel decoder of the foregoing terminal device, wireless device, or core network device.

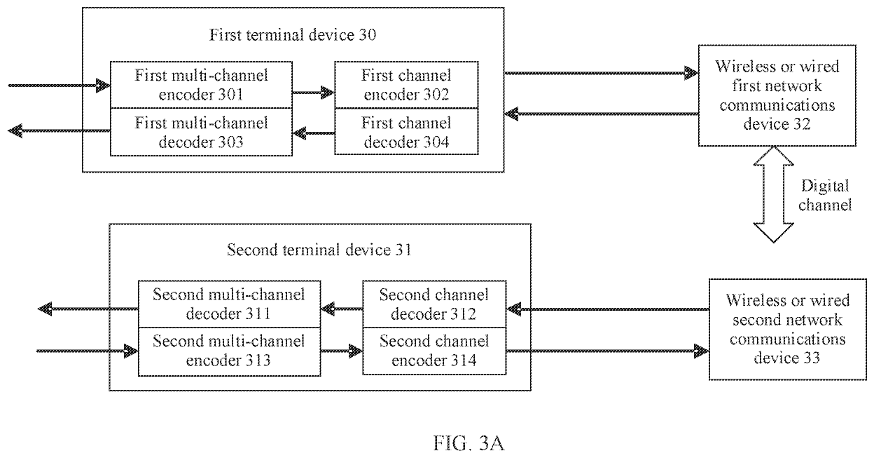

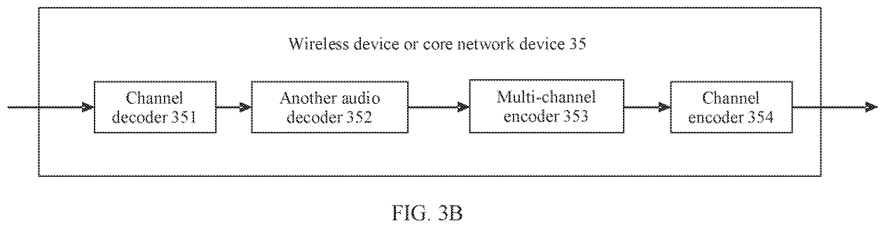

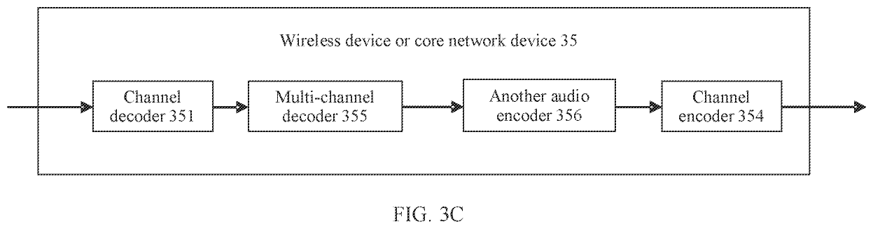

FIG. 3A is a schematic diagram of application of a multi-channel encoder and a multi-channel decoder to a terminal device according to an embodiment of this application. Each terminal device may include a multi-channel encoder, a channel encoder, a multi-channel decoder, and a channel decoder. Specifically, the channel encoder is used to perform channel encoding on a multi-channel signal, and the channel decoder is used to perform channel decoding on a multi-channel signal. For example, a first terminal device 30 may include a first multi-channel encoder 301, a first channel encoder 302, a first multi-channel decoder 303, and a first channel decoder 304. A second terminal device 31 may include a second multi-channel decoder 311, a second channel decoder 312, a second multi-channel encoder 313, and a second channel encoder 314. The first terminal device 30 is connected to a wireless or wired first network communications device 32, the first network communications device 32 is connected to a wireless or wired second network communications device 33 through a digital channel, and the second terminal device 31 is connected to the wireless or wired second network communications device 33. The foregoing wireless or wired network communications device may generally refer to a signal transmission device, for example, a communications base station or a data exchange device. In audio communication, a terminal device serving as a transmit end performs multi-channel encoding on a collected multi-channel signal, then performs channel encoding, and transmits the multi-channel signal on a digital channel by using a wireless network or a core network. A terminal device serving as a receive end performs channel decoding based on a received signal to obtain a multi-channel signal encoded bitstream, and then restores a multi-channel signal through multi-channel decoding, and the terminal device serving as the receive end performs playback.

FIG. 3B is a schematic diagram of application of a multi-channel encoder to a wireless device or a core network device according to an embodiment of this application. The wireless device or core network device 35 includes: a channel decoder 351, another audio decoder 352, a multi-channel encoder 353, and a channel encoder 354. FIG. 3B is similar to NG. 213, and details are not described herein again.

FIG. 3C is a schematic diagram of application of a multi-channel decoder to a wireless device or a core network device according to an embodiment of this application. The wireless device or core network device 35 includes: a channel decoder 351, a multi-channel decoder 355, another audio encoder 356, and a channel encoder 354. FIG. 3C is similar to FIG. 2C, and details are not described herein again.

Stereo encoding processing may be a part of a multi-channel encoder, and stereo decoding processing may be a part of a multi-channel decoder. For example, performing multi-channel encoding on a collected multi-channel signal may be performing dimension reduction processing on the collected multi-channel signal to obtain a stereo signal, and encoding the obtained stereo signal. A decoder side performs decoding based on a multi-channel signal encoded bitstream, to obtain a stereo signal, and restores a multi-channel signal after upmix processing. Therefore, the embodiments of this application may also be applied to a multi-channel encoder and a multi-channel decoder in a terminal device, a wireless device, or a core network device. In a wireless device or a core network device, if transcoding needs to be implemented, corresponding multi-channel encoding and decoding processing needs to be performed.

In the embodiments of this application, pitch period encoding is an important step in the stereo encoding method. Because voiced sound is generated through quasi-periodic impulse excitation, a time-domain waveform of the voiced sound shows obvious periodicity, which is called pitch period. A pitch period plays an important role in producing high-quality voiced speech because voiced speech is characterized as a quasi-periodic signal composed of sampling points separated by a pitch period. In speech processing, a pitch period may also be represented by a quantity of samples included in a period. In this case, the pitch period is called pitch delay. A pitch delay is an important parameter of an adaptive codebook.

Pitch period estimation mainly refers to a process of estimating a pitch period, Therefore, accuracy of pitch period estimation directly determines correctness of an excitation signal, and accordingly determines synthesized speech signal quality. A small quantity of bit resources are used to indicate a pitch period at medium and low bit rates, which is one of the reasons for quality deterioration of speech encoding. Pitch periods of a primary channel signal and a secondary channel signal are very similar. In the embodiments of this application, the similarity of the pitch periods can be properly used to improve encoding efficiency. The accuracy of pitch period estimation is an important factor affecting overall stereo encoding quality at medium and low rates.

In the embodiments of this application, for parametric stereo encoding performed in frequency domain or in a time-frequency combination case, there is a correlation between a pitch period of a primary channel signal and a pitch period of a secondary channel signal. For encoding of the pitch period of the secondary channel signal, when a pitch period reusing condition of the secondary channel signal is satisfied, the pitch period parameter of the secondary channel signal is reasonably predicted and differential-encoded by using a differential encoding method. In this way, only a small quantity of bit resources are required to be allocated for quantization and encoding of the pitch period of the secondary channel signal. The embodiments of this application can improve a sense of space and sound image stability of stereo signals. In addition, in the embodiments of this application, a relatively small quantity of bit resources are used for the pitch period of the secondary channel signal, so that accuracy of pitch period prediction for the secondary channel signal is ensured. The remaining bit resources are used for other stereo encoding parameters, for example, a fixed codebook. Therefore, encoding efficiency of the secondary channel is improved, and overall stereo encoding quality is finally improved.

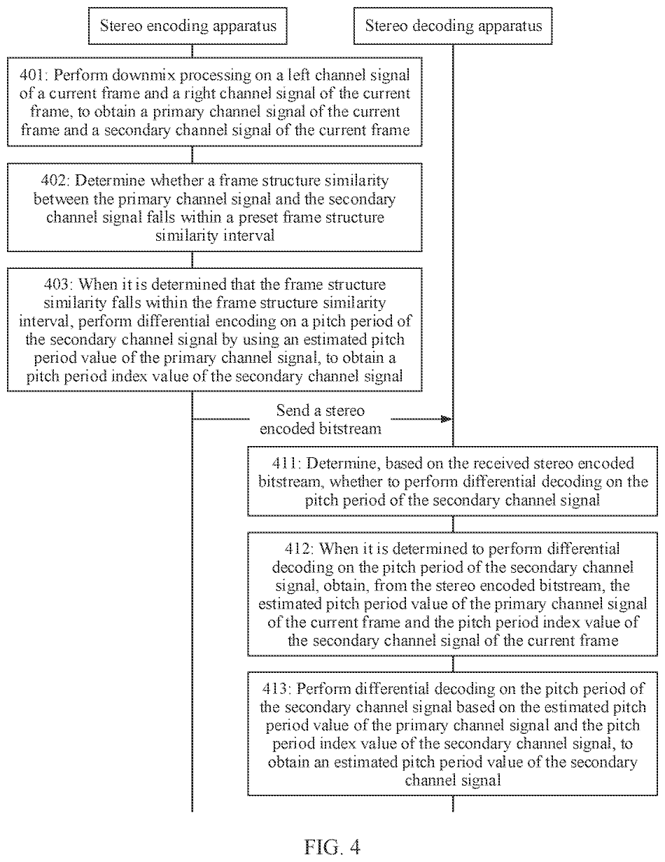

In the embodiments of this application, a pitch period differential encoding method for the secondary channel signal is used for encoding of the pitch period of the secondary channel signal, the pitch period of the primary channel signal is used as a reference value, and bit resources are reallocated to the secondary channel, so as to improve stereo encoding quality. The following describes the stereo encoding method and the stereo decoding method provided in the embodiments of this application based on the foregoing system architecture, the stereo encoding apparatus, and the stereo decoding apparatus, FIG. 4 is a schematic flowchart of interaction between a stereo encoding apparatus and a stereo decoding apparatus according to an embodiment of this application. The following step 401 to step 403 may be performed by the stereo encoding apparatus (briefly referred to as an encoder side below). The following step 411 to step 413 may be performed by the stereo decoding apparatus (briefly referred to as a decoder side below). The interaction mainly includes the following process.

401: Perform downmix processing on a left channel signal of a current frame and a right channel signal of the current frame, to obtain a primary channel signal of the current frame and a secondary channel signal of the current frame.

In this embodiment of this application, the current frame is a stereo signal frame on which encoding processing is currently performed on the encoder side. The left channel signal of the current frame and the right channel signal of the current frame are first obtained, and downmix processing is performed on the left channel signal and the right channel signal, to obtain the primary channel signal of the current frame and the secondary channel signal of the current frame. For example, there are many different implementations of the stereo encoding and decoding technology. For example, the encoder side downmixes time-domain signals into two mono signals. Left and right channel signals are first downmixed into a primary channel signal and a secondary channel signal, where L represents the left channel signal, and R represents the right channel signal. In this case, the primary channel signal may be 0.5*(L+R), which indicates information about a correlation between the two channels, and the secondary channel signal may be 0.5*(L−R), which indicates information about a difference between the two channels.

It should be noted that a downmix process in frequency-domain stereo encoding and a downmix process in time-domain stereo encoding are described in detail in subsequent embodiments.

In some embodiments of this application, the stereo encoding method executed by the encoder side may be applied to a stereo encoding scenario in which an encoding rate of a current frame is lower than a preset rate threshold. The stereo decoding method executed by the decoder side may be applied to a stereo decoding scenario in which a decoding rate of a current frame is lower than a preset rate threshold. The encoding rate of the current frame is an encoding rate used by a stereo signal of the current frame, and the rate threshold is a minimum rate value specified for the stereo signal. When the encoding rate of the current frame is lower than the preset rate threshold, the stereo encoding method provided in this embodiment of this application may be performed. When the decoding rate of the current frame is lower than the preset rate threshold, the stereo decoding method provided in this embodiment of this application may be performed.

Further, in some embodiments of this application, the rate threshold is at least one of the following values: 13.2 kbps, 16.4 kbps, or 24.4 kbps.

The rate threshold may be less than or equal to 13.2 kbps. For example, the rate threshold may alternatively be 16.4 kbps or 24.4 kbps. A specific value of the rate threshold may be determined based on an application scenario. When the encoding rate is relatively low (for example, 24.4 kbps or lower), independent encoding is not performed on the pitch period of the secondary channel, and an estimated pitch period value of the primary channel signal is used as a reference value. The differential encoding method is used to implement encoding of the pitch period of the secondary channel signal, to improve stereo encoding quality.

402: Determine whether to perform differential encoding on the pitch period of the secondary channel signal.

In this embodiment of this application, after the primary channel signal of the current frame and the secondary channel signal of the current frame are obtained, it may be determined, based on the primary channel signal and the secondary channel signal of the current frame, whether differential encoding can be performed on the pitch period of the secondary channel signal. For example, whether to perform differential encoding on the pitch period of the secondary channel signal is determined based on signal characteristics of the primary channel signal and the secondary channel signal of the current frame. For another example, the primary channel signal, the secondary channel signal, and a preset decision condition may be used to determine whether to perform differential encoding on the pitch period of the secondary channel signal. There are a lot of manners of using the primary channel signal and the secondary channel signal to determine whether to perform differential encoding, which are separately described in detail in subsequent embodiments.

In this embodiment of this application, step 402 of determining whether to perform differential encoding on the pitch period of the secondary channel signal includes: encoding the primary channel signal of the current frame, to obtain the estimated pitch period value of the primary channel signal; performing open-loop pitch period analysis on the secondary channel signal of the current frame, to obtain an estimated open-loop pitch period value of the secondary channel signal; determining whether a difference between the estimated pitch period value of the primary channel signal and the estimated open-loop pitch period value of the secondary channel signal exceeds a preset secondary channel pitch period differential encoding threshold; and when the difference exceeds the secondary channel pitch period differential encoding threshold, determining to perform differential encoding on the pitch period of the secondary channel signal; or when the difference does not exceed the secondary channel pitch period differential encoding threshold, determining to skip performing differential encoding on the pitch period of the secondary channel signal.

In this embodiment of this application, after the primary channel signal of the current frame is obtained in step 401, encoding may be performed based on the primary channel signal, to obtain the estimated pitch period value of the primary channel signal. Specifically, in primary channel encoding, pitch period estimation is performed through a combination of open-loop pitch analysis and closed-loop pitch search, so as to improve accuracy of pitch period estimation. A pitch period of a speech signal may be estimated by using a plurality of methods, for example, using an autocorrelation function, or using a short-term average amplitude difference. A pitch period estimation algorithm is based on the autocorrelation function. The autocorrelation function has a peak at an integer multiple of a pitch period, and this feature can be used to estimate the pitch period. In order to improve accuracy of pitch prediction and approximate an actual pitch period of speech better, a fractional delay with a sampling resolution of ⅓ is used for pitch period detection. In order to reduce a computation amount of pitch period estimation, pitch period estimation includes two steps: open-loop pitch analysis and closed-loop pitch search, Open-loop pitch analysis is used to roughly estimate an integer delay of a frame of speech to obtain a candidate integer delay. Closed-loop pitch search is used to finely estimate a pitch delay in the vicinity of the integer delay, and closed-loop pitch search is performed once per subframe. Open-loop pitch analysis is performed once per frame, to compute autocorrelation, normalization, and an optimum open-loop integer delay. The estimated pitch period value of the primary channel signal may be obtained by using the foregoing process.

After the secondary channel signal of the current frame is obtained, open-loop pitch period analysis may be performed on the secondary channel signal, to obtain the estimated open-loop pitch period value of the secondary channel signal. A specific process of the open-loop pitch period analysis is not described in detail.

In this embodiment of this application, after the estimated pitch period value of the primary channel signal and the estimated open-loop pitch period value of the secondary channel signal are obtained, the difference between the estimated pitch period value of the primary channel signal and the estimated open-loop pitch period value of the secondary channel signal may be calculated, and then it is determined whether the difference exceeds the preset secondary channel pitch period differential encoding threshold. The secondary channel pitch period differential encoding threshold may be preset, and may be flexibly configured with reference to a stereo encoding scenario. When the difference exceeds the secondary channel pitch period differential encoding threshold, it is determined to perform differential encoding, or when the difference does not exceed the secondary channel pitch period differential encoding threshold, it is determined not to perform differential encoding.

It should be noted that, in this embodiment of this application, a manner of determining whether to perform differential encoding on the pitch period of the secondary channel signal is not limited to the foregoing determining through comparison of the difference and the secondary channel pitch period differential encoding threshold. For example, it may be alternatively determined based on whether a result of dividing the difference by the secondary channel pitch period differential encoding threshold is less than 1, For another example, the estimated pitch period value of the primary channel signal may be divided by the estimated open-loop pitch period value of the secondary channel signal, and a value of the obtained division result is compared with the secondary channel pitch period differential encoding threshold. In addition, a specific value of the secondary channel pitch period differential encoding threshold may be determined with reference to an application scenario. This is not limited herein.

For example, in secondary channel encoding, a pitch period differential encoding decision of the secondary channel is performed based on the estimated pitch period value of the primary channel signal and the estimated open-loop pitch period value of the secondary channel signal. For example, a decision condition that may be used is: DIFF=|Σ(pitch[0])−Σ(pitch[1])|.

DIFF represents the difference between the estimated pitch period value of the primary channel signal and the estimated open-loop pitch period value of the secondary channel signal. |Σ(pitch[0])−Σ(pitch[1])| represents an absolute value of the difference between Σ(pitch[0]) and Σ(pitch[1]). Σ(pitch[0]) represents the estimated pitch period value of the primary channel signal, and Σ(pitch[1]) represents the estimated open-loop pitch period value of the secondary channel signal.

The decision condition that can be used in this embodiment of this application may not be limited to the foregoing formula. For example, after the calculation result of |Σ(pitch[0])−Σ(pitch[1])| is obtained, a correction factor may be further set, and a result of multiplying |Σ(pitch[0])−Σ(pitch[1])| by the correction factor may be used as the final output DIFF. For another example, a conditional threshold constant may be added to or subtracted from the right part of the equation DIFF=|Σ(pitch[0])−Σ(pitch[1])|, to obtain the final DIFF.

In this embodiment of this application, after it is determined whether to perform differential encoding on the pitch period of the secondary channel signal, whether to perform step 403 is determined based on a result of the foregoing determining. When it is determined to perform differential encoding on the pitch period of the secondary channel signal, the subsequent step 403 is triggered to be performed.

In some embodiments of this application, after step 402 of determining whether to perform differential encoding on the pitch period of the secondary channel signal, the method provided in this embodiment of this application further includes: when determining to perform differential encoding on the pitch period of the secondary channel signal, configuring a secondary channel pitch period differential encoding flag in the current frame to a preset first value, where a stereo encoded bitstream carries the secondary channel pitch period differential encoding flag, and the first value is used to indicate to perform differential encoding on the pitch period of the secondary channel signal.

The encoder side obtains the secondary channel pitch period differential encoding flag. A value of the secondary channel pitch period differential encoding flag may be configured based on whether to perform differential encoding on the pitch period of the secondary channel signal. The secondary channel pitch period differential encoding flag is used to indicate whether to perform differential encoding on the pitch period of the secondary channel signal.

In this embodiment of this application, the secondary channel pitch period differential encoding flag may have a plurality of values. For example, the secondary channel pitch period differential encoding flag may be the preset first value or a second value. The following describes an example of a method for configuring the secondary channel pitch period differential encoding flag. When it is determined to perform differential encoding on the pitch period of the secondary channel signal, the secondary channel pitch period differential encoding flag is configured to the first value. Based on the fact that the secondary channel pitch period differential encoding flag indicates the first value, the decoder side can determine that differential decoding may be performed on the pitch period of the secondary channel signal. For example, the value of the secondary channel pitch period differential encoding flag may be 0 or 1, where the first value is and the second value is 0.

For example, the secondary channel pitch period differential encoding flag is indicated by Pitch_reuse_flag. DIFF_THR is the preset secondary channel pitch period differential encoding threshold. It is determined, based on different encoding rates, that the secondary channel pitch period differential encoding threshold is a specific value in {1, 3, 6}. For example, when DIFF>DIFF_THR, Pitch_reuse_flag=1, and it is determined that pitch period differential encoding for the secondary channel signal is used in the current frame. When DIFF≤DIFF_THR, Pitch_reuse_flag=0. In this case, pitch period differential encoding is not performed, and independent encoding for the secondary channel signal is used.

In some embodiments of this application, after step 402 of determining whether to perform differential encoding on the pitch period of the secondary channel signal, the method provided in this embodiment of this application further includes: when determining to skip performing differential encoding on the pitch period of the secondary channel signal and skip reusing the estimated pitch period value of the primary channel signal as the pitch period of the secondary channel signal, separately encoding the pitch period of the secondary channel signal and a pitch period of the primary channel signal.

When differential encoding is not performed on the pitch period of the secondary channel signal, and the estimated pitch period value of the primary channel signal is not reused as the pitch period of the secondary channel signal, a pitch period independent encoding method for the secondary channel may be used in this embodiment of this application, to encode the pitch period of the secondary channel signal, so that the pitch period of the secondary channel signal can be encoded.

In some embodiments of this application, after step 402 of determining whether to perform differential encoding on the pitch period of the secondary channel signal, the method provided in this embodiment of this application further includes: when determining to skip performing differential encoding on the pitch period of the secondary channel signal and reuse the estimated pitch period value of the primary channel signal as the pitch period of the secondary channel signal, configuring a secondary channel signal pitch period reuse flag to a preset fourth value, and using the stereo encoded bitstream to carry the secondary channel signal pitch period reuse flag, where the fourth value is used to indicate to reuse the estimated pitch period value of the primary channel signal as the pitch period of the secondary channel signal.

When differential encoding is not performed on the pitch period of the secondary channel signal, a pitch period reusing method may be used in this embodiment of this application. To be specific, the encoder side does not encode the pitch period of the secondary channel, and the stereo encoded bitstream carries the secondary channel signal pitch period reuse flag. The secondary channel signal pitch period reuse flag is used to indicate whether the pitch period of the secondary channel signal reuses the estimated pitch period value of the primary channel signal. When the secondary channel signal pitch period reuse flag indicates that the pitch period of the secondary channel signal reuses the estimated pitch period value of the primary channel signal, the decoder side may use, based on the secondary channel signal pitch period reuse flag, the pitch period of the primary channel signal as the pitch period of the secondary channel signal for decoding.

In some embodiments of this application, after step 402 of determining whether to perform differential encoding on the pitch period of the secondary channel signal, the method provided in this embodiment of this application further includes: when determining to skip performing differential encoding on the pitch period of the secondary channel signal, configuring a secondary channel pitch period differential encoding flag to a preset second value, where the stereo encoded bitstream carries the secondary channel pitch period differential encoding flag, and the second value is used to indicate to skip performing differential encoding on the pitch period of the secondary channel signal; when determining to skip reusing the estimated pitch period value of the primary channel signal as the pitch period of the secondary channel signal, configuring a secondary channel signal pitch period reuse flag to a preset third value, where the stereo encoded bitstream carries the secondary channel signal pitch period reuse flag, and the third value is used to indicate to skip reusing the estimated pitch period value of the primary channel signal as the pitch period of the secondary channel signal; and separately encoding the pitch period of the secondary channel signal and the pitch period of the primary channel signal.

The secondary channel pitch period differential encoding flag may have a plurality of values. For example, the secondary channel pitch period differential encoding flag may be the preset first value or the second value. The following describes an example of a method for configuring the secondary channel pitch period differential encoding flag. When it is determined to skip performing differential encoding on the pitch period of the secondary channel signal, the secondary channel pitch period differential encoding flag is configured to the second value. Based on the fact that the secondary channel pitch period differential encoding flag indicates the second value, the decoder side can determine that differential decoding may not be performed on the pitch period of the secondary channel signal. For example, a value of the secondary channel pitch period differential encoding flag may be 0 or 1, the first value is 1, and the second value is 0. Based on the fact that the secondary channel pitch period differential encoding flag indicates the second value, the decoder side can determine not to perform differential decoding on the pitch period of the secondary channel signal.

The secondary channel pitch period reuse flag may have a plurality of values. For example, the secondary channel pitch period reuse flag may be the preset fourth value or the third value. The following describes an example of a method for configuring the secondary channel pitch period reuse flag. When it is determined to skip reusing the estimated pitch period value of the primary channel signal as the pitch period of the secondary channel signal, the secondary channel pitch period reuse flag is configured to the third value. Based on the fact that the secondary channel pitch period reuse flag indicates the third value, the decoder side can determine not to reuse the estimated pitch period value of the primary channel signal as the pitch period of the secondary channel signal. For example, a value of the secondary channel pitch period reuse flag may be 0 or 1, the fourth value is 1, and the third value is 0. When the encoder side determines to skip performing differential encoding on the pitch period of the secondary channel signal and skip reusing the estimated pitch period value of the primary channel signal as the pitch period of the secondary channel signal, the encoder side may use an independent encoding method, that is, separately encode the pitch period of the secondary channel signal and the pitch period of the primary channel signal.

It should be noted that, in this embodiment of this application, when it is determined not to perform differential encoding on the pitch period of the secondary channel signal, the pitch period independent encoding method for the secondary channel may be used to encode the pitch period of the secondary channel signal. In addition, when it is determined not to perform differential encoding on the pitch period of the secondary channel signal, a pitch period reusing method may be alternatively used. The stereo encoding method executed by the encoder side may be applied to a stereo encoding scenario in which an encoding rate of the current frame is lower than a preset rate threshold. If differential encoding is not performed by using the pitch period of the secondary channel signal, the secondary channel pitch period reusing method may be used. That is, the secondary channel pitch period is not encoded on the encoder side, and the stereo encoded bitstream carries the secondary channel signal pitch period reuse flag. The secondary channel signal pitch period reuse flag is used to indicate whether the pitch period of the secondary channel signal reuses the estimated pitch period value of the primary channel signal, and when the secondary channel signal pitch period reuse flag indicates that the pitch period of the secondary channel signal reuses the estimated pitch value period of the primary channel signal, the decoder side may use, based on the secondary channel signal pitch period reuse flag, the pitch period of the primary channel signal as the pitch period of the secondary channel signal for decoding.

In some embodiments of this application, after step 402 of determining whether to perform differential encoding on the pitch period of the secondary channel signal, the method provided in this embodiment of this application further includes: when determining to skip performing differential encoding on the pitch period of the secondary channel signal, configuring a secondary channel pitch period differential encoding flag to a preset second value, where the stereo encoded bitstream carries the secondary channel pitch period differential encoding flag, and the second value is used to indicate to skip performing differential encoding on the pitch period of the secondary channel signal; when determining to reuse the estimated pitch period value of the primary channel signal as the pitch period of the secondary channel signal, configuring a secondary channel signal pitch period reuse flag to a preset fourth value, where the stereo encoded bitstream carries the secondary channel signal pitch period reuse flag, and the fourth value is used to indicate to reuse the estimated pitch period value of the primary channel signal as the pitch period of the secondary channel signal.

The secondary channel pitch period differential encoding flag may have a plurality of values. For example, the secondary channel pitch period differential encoding flag may be the preset first value or the second value. The following describes an example of a method for configuring the secondary channel pitch period differential encoding flag. When it is determined to skip performing differential encoding on the pitch period of the secondary channel signal, the secondary channel pitch period differential encoding flag is configured to the second value. Based on the fact that the secondary channel pitch period differential encoding flag indicates the second value, the decoder side can determine that differential decoding may not be performed on the pitch period of the secondary channel signal. For example, a value of the secondary channel pitch period differential encoding flag may be 0 or 1, the first value is 1, and the second value is 0. Based on the fact that the secondary channel pitch period differential encoding flag indicates the second value, the decoder side can determine not to perform differential decoding on the pitch period of the secondary channel signal.

The secondary channel pitch period reuse flag may have a plurality of values. For example, the secondary channel pitch period reuse flag may be the preset fourth value or the third value. When the encoder side determines to skip performing differential encoding on the pitch period of the secondary channel signal and reuse the estimated pitch period value of the primary channel signal as the pitch period of the secondary channel signal, the value of the secondary channel signal pitch period reuse flag is configured to the fourth value. The following describes an example of a method for configuring the secondary channel pitch period reuse flag. When it is determined to reuse the estimated pitch period value of the primary channel signal as the pitch period of the secondary channel signal, the secondary channel pitch period reuse flag is configured to the fourth value. Based on the fact that the secondary channel pitch period reuse flag indicates the fourth value, the decoder side can determine to reuse the estimated pitch period value of the primary channel signal as the pitch period of the secondary channel signal. For example, a value of the secondary channel pitch period reuse flag may be 0 or 1, the fourth value is 1, and the third value is 0.

403: When determining to perform differential encoding on the pitch period of the secondary channel signal, perform differential encoding on the pitch period of the secondary channel signal by using the estimated pitch period value of the primary channel signal, to obtain a pitch period index value of the secondary channel signal, where the pitch period index value of the secondary channel signal is used to generate the to-be-sent stereo encoded bitstream.

In this embodiment of this application, when it is determined that differential encoding may be performed on the pitch period of the secondary channel signal, differential encoding may be performed on the pitch period of the secondary channel signal by using the estimated pitch period value of the primary channel signal. Because the estimated pitch period value of the primary channel signal is used in the differential encoding, an estimated pitch period value of the secondary channel signal is accurately encoded through differential encoding in consideration of pitch period similarity between the primary channel signal and the secondary channel signal. The secondary channel signal can be more accurately decoded by using the estimated pitch period value of the secondary channel signal, so that a sense of space and sound image stability of the stereo signal can be improved. In addition, if the pitch period of the secondary channel signal needs to be independently encoded, differential encoding is performed on the pitch period of the secondary channel signal in this embodiment of this application, so that bit resource overheads used for independently encoding the pitch period of the secondary channel signal can be reduced, and saved bits can be allocated to other stereo encoding parameters, to implement accurate secondary channel pitch period encoding and improve overall stereo encoding quality.

In this embodiment of this application, after the primary channel signal of the current frame is obtained in step 401, encoding may be performed based on the primary channel signal, to obtain the estimated pitch period value of the primary channel signal. Specifically, in primary channel encoding, pitch period estimation is performed through a combination of open-loop pitch analysis and closed-loop pitch search, so as to improve accuracy of pitch period estimation. A pitch period of a speech signal may be estimated by using a plurality of methods, for example, using an autocorrelation function, or using a short-term average amplitude difference. A pitch period estimation algorithm is based on the autocorrelation function. The autocorrelation function has a peak at an integer multiple of a pitch period, and this feature can be used to estimate the pitch period. In order to improve accuracy of pitch prediction and approximate an actual pitch period of speech better, a fractional delay with a sampling resolution of ⅓ is used for pitch period detection. In order to reduce a computation amount of pitch period estimation, pitch period estimation includes two steps: open-loop pitch analysis and closed-loop pitch search. Open-loop pitch analysis is used to roughly estimate an integer delay of a frame of speech to obtain a candidate integer delay. Closed-loop pitch search is used to finely estimate a pitch delay in the vicinity of the integer delay, and closed-loop pitch search is performed once per subframe. Open-loop pitch analysis is performed once per frame, to compute autocorrelation, normalization, and an optimum open-loop integer delay. The estimated pitch period value of the primary channel signal may be obtained by using the foregoing process.

The following describes a specific process of differential encoding in this embodiment of this application. Specifically, step 403 of performing differential encoding on the pitch period of the secondary channel signal by using the estimated pitch period value of the primary channel signal, to obtain a pitch period index value of the secondary channel signal includes: performing secondary channel signal closed-loop pitch period search based on the estimated pitch period value of the primary channel signal, to obtain the estimated pitch period value of the secondary channel signal, determining an upper limit of the pitch period index value of the secondary channel signal based on a pitch period search range adjustment factor of the secondary channel signal; and calculating the pitch period index value of the secondary channel signal based on the estimated pitch period value of the primary channel signal, the estimated pitch period value of the secondary channel signal, and the upper limit of the pitch period index value of the secondary channel signal.

The encoder side first performs secondary channel signal closed-loop pitch period search based on the estimated pitch period value of the secondary channel signal, to determine the estimated pitch period value of the secondary channel signal. The following describes a specific process of closed-loop pitch period search in detail. In some embodiments of this application, the performing secondary channel signal closed-loop pitch period search based on the estimated pitch period value of the primary channel signal, to obtain the estimated pitch period value of the secondary channel signal includes: determining a closed-loop pitch period reference value of the secondary channel signal based on the estimated pitch period value of the primary channel signal and a quantity of subframes into which the secondary channel signal of the current frame is divided; and performing closed-loop pitch period search by using integer precision and fractional precision and by using the closed-loop pitch period reference value of the secondary channel signal as a start point of the secondary channel signal closed-loop pitch period search, to obtain the estimated pitch period value of the secondary channel signal.

The quantity of subframes into which the secondary channel signal of the current frame is divided may be determined based on a subframe configuration of the secondary channel signal. For example, the secondary channel signal may be divided into four subframes or three subframes, which is specifically determined with reference to an application scenario. After the estimated pitch period value of the primary channel signal is obtained, the estimated pitch period value of the primary channel signal and the quantity of subframes into which the secondary channel signal is divided may be used to calculate the closed-loop pitch period reference value of the secondary channel signal. The closed-loop pitch period reference value of the secondary channel signal is a reference value determined based on the estimated pitch period value of the primary channel signal. The closed-loop pitch period reference value of the secondary channel signal represents a closed-loop pitch period of the secondary channel signal that is determined by using the estimated pitch period value of the primary channel signal as a reference. For example, one method is to directly use a pitch period of the primary channel signal as the closed-loop pitch period reference value of the secondary channel signal. That is, four values are selected from pitch periods of five subframes of the primary channel signal as closed-loop pitch period reference values of four subframes of the secondary channel signal. In another method, the pitch periods of the five subframes of the primary channel signal are mapped to closed-loop pitch period reference values of the four subframes of the secondary channel signal by using an interpolation method.

Specifically, closed-loop pitch period search is performed by using integer precision and downsampling fractional precision and by using the closed-loop pitch period reference value of the secondary channel signal as the start point of the secondary channel signal closed-loop pitch period search, and finally an interpolated normalized correlation is computed to obtain the estimated pitch period value of the secondary channel signal. For a process of calculating the estimated pitch period value of the secondary channel signal, refer to an example in a subsequent embodiment.

The pitch period search range adjustment factor of the secondary channel signal may be used to adjust the pitch period index value of the secondary channel signal, to determine the upper limit of the pitch period index value of the secondary channel signal. The upper limit of the pitch period index value of the secondary channel signal indicates an upper limit value that the pitch period index value of the secondary channel signal cannot exceed.

Further, in some embodiments of this application, the determining a closed-loop pitch period reference value of the secondary channel signal based on the estimated pitch period value of the primary channel signal and a quantity of subframes into which the secondary channel signal of the current frame is divided includes: determining a closed-loop pitch period integer part loc_T0 of the secondary channel signal and a closed-loop pitch period fractional part loc_frac_prim of the secondary channel signal based on the estimated pitch period value of the primary channel signal; and calculating the closed-loop pitch period reference value f_pitch_prim of the secondary channel signal in the following manner:

f_pitch_prim=loc_T0+loc_frac_prim/N;

where N represents the quantity of subframes into which the secondary channel signal is divided.

Specifically, the closed-loop pitch period integer part and the closed-loop pitch period fractional part of the secondary channel signal are first determined based on the estimated pitch period value of the primary channel signal. For example, an integer part of the estimated pitch period value of the primary channel signal is directly used as the closed-loop pitch period integer part of the secondary channel signal, and a fractional part of the estimated pitch period value of the primary channel signal is used as the closed-loop pitch period fractional part of the secondary channel signal. Alternatively, the estimated pitch period value of the primary channel signal may be mapped to the closed-loop pitch period integer part and the closed-loop pitch period fractional part of the secondary channel signal by using an interpolation method. For example, according to either of the foregoing methods, the closed-loop pitch period integer part loc_T0 and the closed-loop pitch period fractional part loc_frac_prim of the secondary channel may be obtained.

N represents the quantity of subframes into which the secondary channel signal is divided. For example, a value of N may be 3, 4, 5, or the like. A specific value depends on an application scenario. The closed-loop pitch period reference value of the secondary channel signal may be calculated by using the foregoing formula. In this embodiment of this application, the calculation of the closed-loop pitch period reference value of the secondary channel signal may not be limited to the foregoing formula. For example, after a result of loc_T0+loc_frac_prim/N is obtained, a correction factor may further be set. A result of multiplying the correction factor by loc_T0+loc_frac_prim/N may be used as the final output f_pitch_prim. For another example, N on the right side of the equation f_pitch_prim=loc_T0+loc_frac_prim/N may be replaced with N−1, and the final f_pitch_prim may also be calculated.

In some embodiments of this application, the determining an upper limit of the pitch period index value of the secondary channel signal based on a pitch period search range adjustment factor of the secondary channel signal includes: calculating the upper limit soft_reuse_index_high_limit of the pitch period index value of the secondary channel signal in the following manner:

soft_reuse_index_high_limit=0.5+2^{Z};

where Z is the pitch period search range adjustment factor of the secondary channel signal, and a value of Z is 3, 4, or 5.

To calculate the pitch period index upper limit of the secondary channel signal in differential encoding, the pitch period search range adjustment factor Z of the secondary channel signal needs to be first determined. Then, soft_reuse_index_high_limit is obtained by using the following formula: soft_reuse_index_high_limit=0.5+2^{Z}. For example, Z may be 3, 4, or 5, and a specific value of Z is not limited herein, depending on an application scenario.

After determining the estimated pitch period value of the primary channel signal, the estimated pitch period value of the secondary channel signal, and the upper limit of the pitch period index value of the secondary channel signal, the encoder side performs differential encoding based on the estimated pitch period value of the primary channel signal, the estimated pitch period value of the secondary channel signal, and the upper limit of the pitch period index value of the secondary channel signal, and outputs the pitch period index value of the secondary channel signal.

Further, in some embodiments of this application, the calculating the pitch period index value of the secondary channel signal based on the estimated pitch period value of the primary channel signal, the estimated pitch period value of the secondary channel signal, and the upper limit of the pitch period index value of the secondary channel signal includes: determining a closed-loop pitch period integer part loc_T0 of the secondary channel signal and a closed-loop pitch period fractional part loc_frac_prim of the secondary channel signal based on the estimated pitch period value of the primary channel signal; and calculating the pitch period index value soft_reuse_index of the secondary channel signal in the following manner:

soft_reuse_index=(N*pitch_soft_reuse+pitch_frac_soft_reuse)−(N*loc_T0+loc_frac_prim)+soft_reuse_index_high_limit/M;

where pitch_soft_reuse represents an integer part of the estimated pitch period value of the secondary channel signal, pitch_frac_soft_reuse represents a fractional part of the estimated pitch period value of the secondary channel signal, soft_reuse_index_high_limit represents the upper limit of the pitch period index value of the secondary channel signal, N represents a quantity of subframes into which the secondary channel signal is divided, M represents an adjustment factor of the upper limit of the pitch period index value of the secondary channel signal, M is a non-zero real number, * represents a multiplication operator, + represents an addition operator, and − represents a subtraction operator.

Specifically, the closed-loop pitch period integer part loc_T0 of the secondary channel signal and the closed-loop pitch period fractional part loc_frac_prim of the secondary channel signal are first determined based on the estimated pitch period value of the primary channel signal. For details, refer to the foregoing calculation process. N represents the quantity of subframes into which the secondary channel signal is divided, for example, a value of N may be 3, 4, or 5. M represents the adjustment factor of the upper limit of the pitch period index value of the secondary channel signal, and M is a non-zero real number, for example, a value of M may be 2 or 3. Values of N and M depend on an application scenario, and are not limited herein.

In this embodiment of this application, calculation of the pitch period index value of the secondary channel signal may not be limited to the foregoing formula. For example, after a result of (N*pitch_soft_reuse+pitch_frac_soft_reuse)−(N*loc_T0+loc_frac_prim)+soft_reuse_index_high_limit/M is calculated, a correction factor may be further set, and a result obtained by multiplying the correction factor by (N*pitch_soft_reuse+pitch_frac_soft_reuse)−(N*loc_T0+loc_frac_prim)+soft_reuse_index_high_limit/M may be used as a final output soft_reuse_index.

For another example, a correction factor may further be added to the right of the equation: soft_reuse_index=(N*pitch_soft_reuse+pitch_frac_soft_reuse)−(N*loc_T0+loc_frac_prim)+soft_reuse_index_high_limit/M. A specific value of the correction factor is not limited, and a final soft_reuse_index may also be calculated.

In this embodiment of this application, the stereo encoded bitstream generated by the encoder side may be stored in a computer-readable storage medium.

In this embodiment of this application, differential encoding is performed on the pitch period of the secondary channel signal by using the estimated pitch period value of the primary channel signal, to obtain the pitch period index value of the secondary channel signal. The pitch period index value of the secondary channel signal is used to indicate the pitch period of the secondary channel signal. After the pitch period index value of the secondary channel signal is obtained, the pitch period index value of the secondary channel signal may be further used to generate the to-be-sent stereo encoded bitstream. After generating the stereo encoded bitstream, the encoder side may output the stereo encoded bitstream, and send the stereo encoded bitstream to the decoder side through an audio transmission channel.

411: Determine, based on the received stereo encoded bitstream, whether to perform differential decoding on the pitch period of the secondary channel signal.

In this embodiment of this application, it is determined, based on the received stereo encoded bitstream, whether to perform differential decoding on the pitch period of the secondary channel signal. For example, the decoder side may determine, based on indication information carried in the stereo encoded bitstream, whether to perform differential decoding on the pitch period of the secondary channel signal. For another example, after a transmission environment of the stereo signal is preconfigured, whether to perform differential decoding may be preconfigured. In this case, the decoder side may further determine, based on a result of the preconfiguration, whether to perform differential decoding on the pitch period of the secondary channel signal.

In some embodiments of this application, step 411 of determining, based on the received stereo encoded bitstream, whether to perform differential decoding on the pitch period of the secondary channel signal includes: obtaining the secondary channel pitch period differential encoding flag from the current frame; and when the secondary channel pitch period differential encoding flag is the preset first value, determining to perform differential decoding on the pitch period of the secondary channel signal.

In this embodiment of this application, the secondary channel pitch period differential encoding flag may have a plurality of values. For example, the secondary channel pitch period differential encoding flag may be the preset first value or the second value. For example, the value of the secondary channel pitch period differential encoding flag may be 0 or 1, where the first value is 1, and the second value is 0. For example, when the value of the secondary channel pitch period differential encoding flag is 1, step 412 is triggered.

For example, the secondary channel pitch period differential encoding flag is Pitch_reuse_flag. For example, during secondary channel decoding, the secondary channel pitch period differential encoding flag Pitch_reuse_flag is obtained. When differential decoding can be performed on the pitch period of the secondary channel signal, Pitch_reuse_flag is 1, and the differential decoding method in this embodiment of this application is performed. When differential decoding cannot be performed on the pitch period of the secondary channel signal, Pitch_reuse_flag is 0, and an independent decoding method is performed. For example, in this embodiment of this application, the differential decoding process in step 412 and step 413 is performed only when Pitch_reuse_flag is 1.

In some embodiments of this application, the method provided in this embodiment of this application further includes; when determining to skip performing differential decoding on the pitch period of the secondary channel signal and skip reusing the estimated pitch period value of the primary channel signal as the pitch period of the secondary channel signal, decoding the pitch period of the secondary channel signal from the stereo encoded bitstream.

When the decoder side determines not to perform differential decoding on the pitch period of the secondary channel signal, and not to reuse the estimated pitch period value of the primary channel signal as the pitch period of the secondary channel signal, a pitch period independent decoding method for the secondary channel may be used in this embodiment of this application, to decode the pitch period of the secondary channel signal, so that the pitch period of the secondary channel signal can be decoded.

In some embodiments of this application, the method provided in this embodiment of this application further includes; when determining to skip performing differential decoding on the pitch period of the secondary channel signal and reuse the estimated pitch period value of the primary channel signal as the pitch period of the secondary channel signal, using the estimated pitch period value of the primary channel signal as the pitch period of the secondary channel signal.

When the decoder side determines not to perform differential decoding on the pitch period of the secondary channel signal, a pitch period reusing method may be used in this embodiment of this application. For example, when the secondary channel signal pitch period reuse flag indicates that the pitch period of the secondary channel signal reuses the estimated pitch period value of the primary channel signal, the decoder side may perform decoding based on the secondary channel signal pitch period reuse flag by using the pitch period of the primary channel signal as the pitch period of the secondary channel signal.

In some other embodiments of this application, based on the value of the secondary channel pitch period differential encoding flag, the stereo decoding method performed by the decoder side may further include the following steps: when the secondary channel pitch period differential encoding flag is the preset second value, and the secondary channel signal pitch period reuse flag carried in the stereo encoded bitstream is the preset third value, determining not to perform differential decoding on the pitch period of the secondary channel signal, and not to reuse the estimated pitch period value of the primary channel signal as the pitch period of the secondary channel signal, and decoding the pitch period of the secondary channel signal from the stereo encoded bitstream.

In some other embodiments of this application, based on the value of the secondary channel pitch period differential encoding flag, the stereo decoding method performed by the decoder side may further include the following steps: when the secondary channel pitch period differential encoding flag is the preset second value, and the secondary channel signal pitch period reuse flag carried in the stereo encoded bitstream is the preset fourth value, determining not to perform differential decoding on the pitch period of the secondary channel signal, and using the estimated pitch period value of the primary channel signal as the pitch period of the secondary channel signal.

When the secondary channel pitch period differential encoding flag is the second value, it is determined not to perform the differential decoding process in step 412 and step 413, and the secondary channel signal pitch period reuse flag carried in the stereo encoded bitstream is further parsed. The secondary channel signal pitch period reuse flag is used to indicate whether the pitch period of the secondary channel signal reuses the estimated pitch period value of the primary channel signal. When the value of the secondary channel signal pitch period reuse flag is the fourth value, it indicates that the pitch period of the secondary channel signal reuses the estimated pitch period value of the primary channel signal, and the decoder side may perform decoding based on the secondary channel signal pitch period reuse flag by using the pitch period of the primary channel signal as the pitch period of the secondary channel signal. When the value of the secondary channel signal pitch period reuse flag is the third value, it indicates that the pitch period of the secondary channel signal does not reuse the estimated pitch period value of the primary channel signal, and the decoder side decodes the pitch period of the secondary channel signal from the stereo encoded bitstream. The pitch period of the secondary channel signal and the pitch period of the primary channel signal may be decoded separately, that is, the pitch period of the secondary channel signal is decoded independently. The decoder side may determine, based on the secondary channel pitch period differential encoding flag carried in the stereo encoded bitstream, to execute the differential decoding method or the independent decoding method.

It should be noted that, in this embodiment of this application, when it is determined not to perform differential decoding on the pitch period of the secondary channel signal, the pitch period independent decoding method for the secondary channel may be used to decode the pitch period of the secondary channel signal. In addition, when it is determined not to perform differential decoding on the pitch period of the secondary channel signal, a pitch period reusing method may be alternatively used. The stereo decoding method executed by the decoder side may be applied to a stereo decoding scenario in which a decoding rate of the current frame is lower than a preset rate threshold. If the stereo encoded bitstream carries the secondary channel signal pitch period reuse flag, the secondary channel signal pitch period reuse flag is used to indicate whether the pitch period of the secondary channel signal reuses the estimated pitch period value of the primary channel signal. When the secondary channel signal pitch period reuse flag indicates that the pitch period of the secondary channel signal reuses the estimated pitch value period of the primary channel signal, the decoder side may use, based on the secondary channel signal pitch period reuse flag, the pitch period of the primary channel signal as the pitch period of the secondary channel signal for decoding.

412: When it is determined to perform differential decoding on the pitch period of the secondary channel signal, obtain, from the stereo encoded bitstream, the estimated pitch period value of the primary channel of the current frame and the pitch period index value of the secondary channel of the current frame.

In this embodiment of this application, after the encoder side sends the stereo encoded bitstream, the decoder side first receives the stereo encoded bitstream through the audio transmission channel, and then performs channel decoding based on the stereo encoded bitstream. If differential decoding needs to be performed on the pitch period of the secondary channel signal, the pitch period index value of the secondary channel signal of the current frame may be obtained from the stereo encoded bitstream, and the estimated pitch period value of the primary channel signal of the current frame may be obtained from the stereo encoded bitstream.

413: Perform differential decoding on the pitch period of the secondary channel signal based on the estimated pitch period value of the primary channel and the pitch period index value of the secondary channel, to obtain the estimated pitch period value of the secondary channel signal, where the estimated pitch period value of the secondary channel signal is used to decode the stereo encoded bitstream.

In this embodiment of this application, when it is determined, in step 411, that differential decoding needs to be performed on the pitch period of the secondary channel signal, the estimated pitch period value of the primary channel signal and the pitch period index value of the secondary channel signal may be used to perform differential decoding on the pitch period of the secondary channel signal, to accurately decode the pitch period of the secondary channel and improve overall stereo decoding quality.

The following describes a specific differential decoding process in this embodiment of this application. Specifically, step 413 of performing differential decoding on the pitch period of the secondary channel signal based on the estimated pitch period value of the primary channel signal and the pitch period index value of the secondary channel signal includes: determining the closed-loop pitch period reference value of the secondary channel signal based on the estimated pitch period value of the primary channel signal and the quantity of subframes into which the secondary channel signal of the current frame is divided; and determining the upper limit of the pitch period index value of the secondary channel signal based on the pitch period search range adjustment factor of the secondary channel signal; and calculating the estimated pitch period value of the secondary channel signal based on the closed-loop pitch period reference value of the secondary channel signal, the pitch period index value of the secondary channel signal, and the upper limit of the pitch period index value of the secondary channel signal.

For example, the closed-loop pitch period reference value of the secondary channel signal is determined by using the estimated pitch period value of the primary channel signal. For details, refer to the foregoing calculation process. The pitch period search range adjustment factor of the secondary channel signal may be used to adjust the pitch period index value of the secondary channel signal, to determine the upper limit of the pitch period index value of the secondary channel signal. The upper limit of the pitch period index value of the secondary channel signal indicates an upper limit value that the pitch period index value of the secondary channel signal cannot exceed. The pitch period index value of the secondary channel signal may be used to determine the pitch period index value of the secondary channel signal.

After determining the closed-loop pitch period reference value of the secondary channel signal, the pitch period index value of the secondary channel signal, and the upper limit of the pitch period index value of the secondary channel signal, the decoder side performs differential decoding based on the closed-loop pitch period reference value of the secondary channel signal, the pitch period index value of the secondary channel signal, and the upper limit of the pitch period index value of the secondary channel signal, and outputs the estimated pitch period value of the secondary channel signal.

Further, in some embodiments of this application, the calculating the estimated pitch period value of the secondary channel signal based on the closed-loop pitch period reference value of the secondary channel signal, the pitch period index value of the secondary channel signal, and the upper limit of the pitch period index value of the secondary channel signal includes: calculating the estimated pitch period value T0_pitch of the secondary channel signal in the following manner:

T0_pitch=f_pitch_prim+(soft_reuse_index−soft_reuse_index_high_limit/M)/N;

where f_pitch_prim represents the closed-loop pitch period reference value of the secondary channel signal, soft_reuse_index represents the pitch period index value of the secondary channel signal, N represents the quantity of subframes into which the secondary channel signal is divided, M represents an adjustment factor of the upper limit of the pitch period index value of the secondary channel signal, M is a non-zero real number, / represents a division operator, + represents an addition operator, and − represents a subtraction operator.

Specifically, the closed-loop pitch period integer part loc_T0 of the secondary channel signal and the closed-loop pitch period fractional part loc_frac_prim of the secondary channel signal are first determined based on the estimated pitch period value of the primary channel signal. For details, refer to the foregoing calculation process. N represents the quantity of subframes into which the secondary channel signal is divided, for example, a value of N may be 3, 4, or 5. M represents the adjustment factor of the upper limit of the pitch period index value of the secondary channel signal, for example, a value of M may be 2 or 3. Values of N and M depend on an application scenario, and are not limited herein.

In this embodiment of this application, calculation of the estimated pitch period value of the secondary channel signal may not be limited to the foregoing formula. For example, after a result of f_pitch_prim+(soft_reuse_index−soft_reuse_index_high_limit/M)/N is calculated, a correction factor may be further set, and a result obtained by multiplying the correction factor by f_pitch_prim+(soft_reuse_index−soft_reuse_index_high_limit/M)/N may be used as the final output T0_pitch. For another example, a correction factor may further be added to the right of the equation: T0_pitch=f_pitch_prim+(soft_reuse_index−soft_reuse_index_high_limit/M)/N, a specific value of the correction factor is not limited, and the final T0_pitch may also be calculated.

It should be noted that after the estimated pitch period value T0_pitch of the secondary channel signal is calculated, an integer part T0 of the estimated pitch period value and a fractional part T0_frac of the estimated pitch period value of the secondary channel signal may be further calculated based on the estimated pitch period value T0_pitch of the secondary channel signal. For example, T0=INT(T0_pitch), and T0_frac=(T0_pitch−T0)*N.

INT(T0_pitch) indicates to round down T0_pitch to the nearest integer, T0 indicates to decode the integer part of the estimated pitch period value of the secondary channel, and T0_frac indicates to decode the fractional part of the estimated pitch period value of the secondary channel.

According to the description of the examples of the foregoing embodiment, in this embodiment of this application, because differential encoding is performed on the pitch period of the secondary channel signal by using the estimated pitch period value of the primary channel signal, a small quantity of bit resources are required to be allocated to the pitch period of the secondary channel signal for differential encoding. Through differential encoding of the pitch period of the secondary channel signal, a sense of space and sound image stability of the stereo signal can be improved. In addition, in this embodiment of this application, a relatively small quantity of bit resources are used to perform differential encoding on the pitch period of the secondary channel signal. Therefore, saved bit resources may be used for other stereo encoding parameters, so that encoding efficiency of the secondary channel is improved, and finally overall stereo encoding quality is improved. In addition, in this embodiment of this application, when differential decoding can be performed on the pitch period of the secondary channel signal, the estimated pitch period value of the primary channel signal and the pitch period index value of the secondary channel signal may be used to perform differential decoding on the pitch period of the secondary channel signal, to obtain the estimated pitch period value of the secondary channel signal, and the stereo encoded bitstream may be decoded by using the estimated pitch period value of the secondary channel signal. Therefore, a sense of space and sound image stability of the stereo signal can be improved.

To better understand and implement the foregoing solutions in the embodiments of this application, the following provides detailed descriptions by using an example of a corresponding application scenario.

According to the pitch period encoding solution for the secondary channel signal proposed in this embodiment of this application, in a pitch period encoding process of the secondary channel signal, whether differential encoding can be performed on the pitch period of the secondary channel signal is determined, and when differential encoding can be performed on the pitch period of the secondary channel signal, a differential encoding method oriented to the pitch period of the secondary channel signal is used to encode the pitch period of the secondary channel signal. A small quantity of bit resources are used for differential encoding, and saved bits are allocated to other stereo encoding parameters to achieve accurate pitch period encoding for the secondary channel signal and improve the overall stereo encoding quality.

In this embodiment of this application, the stereo signal may be an original stereo signal, or a stereo signal formed by two channels of signals included in a multi-channel signal, or a stereo signal formed by two channels of signals that are jointly generated by a plurality of channels of signals included in a multi-channel signal. The stereo encoding apparatus may constitute an independent stereo encoder, or may be used in a core encoding part in a multi-channel encoder, to encode a stereo signal including two channels of signals jointly generated by a plurality of channels of signals included in a multi-channel signal.

In this embodiment of this application, an example in which the encoding rate of the stereo signal is 24.4 kbps is used for description. It may be understood that this embodiment of this application is not limited to implementation at a 24.4 kbps encoding rate, and may further be applied to stereo encoding at a lower rate.

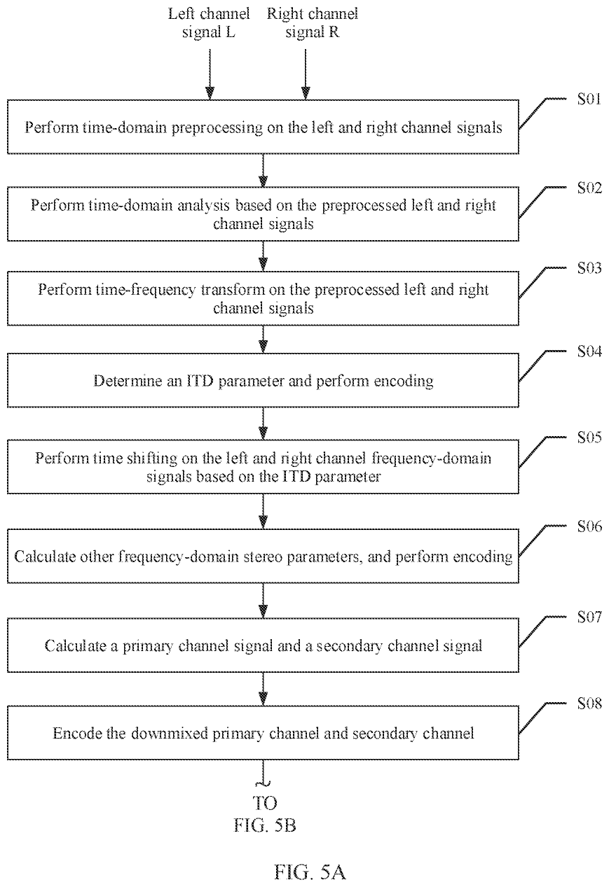

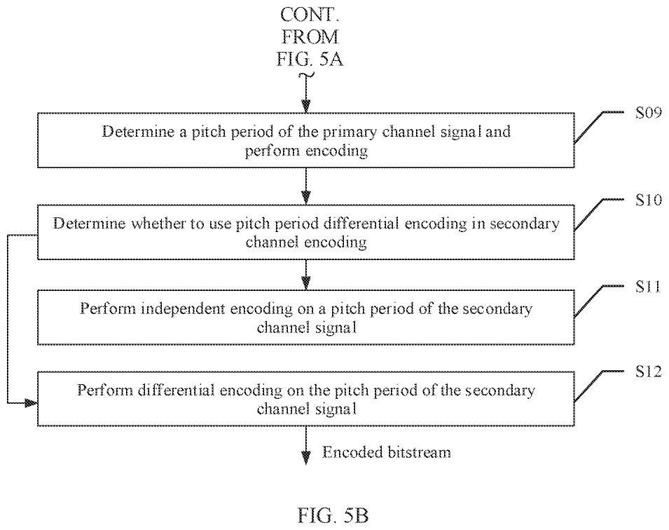

FIG. 5A and FIG. 5B are a schematic flowchart of stereo signal encoding according to an embodiment of this application. This embodiment of this application provides a pitch period encoding determining method in stereo coding. The stereo coding may be time-domain stereo coding, or may be frequency-domain stereo coding, or may be time-frequency combined stereo coding. This is not limited in this embodiment of this application. Using frequency-domain stereo coding as an example, the following describes an encoding/decoding process of stereo coding, and focuses on an encoding process of a pitch period in secondary channel signal coding in subsequent steps.

First, an encoder side of frequency-domain stereo coding is described. Specific implementation steps of the encoder side are as follows:

S01: Perform time-domain preprocessing on left and right channel time-domain signals.

Stereo signal encoding is generally performed through frame division. If a sampling rate of a stereo audio signal is 16 kilohertz (KHz), each frame of signal is 20 milliseconds (ms), and a frame length is denoted as N, N=320, that is, the frame length is equal to 320 sampling points. A stereo signal of a current frame includes a left channel time-domain signal of the current frame and a right channel time-domain signal of the current frame. The left channel time-domain signal of the current frame is denoted as x_{L}(n), and the right channel time-domain signal of the current frame is denoted as x_{R}(n), where n is a sampling point number, and n=0, 1, . . . , N−1. The left and right channel time-domain signals of the current frame are short for the left channel time-domain signal of the current frame and the right channel time-domain signal of the current frame.

Specifically, the performing time-domain preprocessing on left and right channel time-domain signals of the current frame may include: performing high-pass filtering on the left and right channel time-domain signals of the current frame to obtain preprocessed left and right channel time-domain signals of the current frame. The preprocessed left channel time-domain signal of the current frame is denoted as X_{L_HP}(n), and the preprocessed right channel time-domain signal of the current frame is denoted as X_{R_HP}(n). Herein, n is a sampling point number, and n=0, 1, . . . , N−1. The preprocessed left and right channel time-domain signals of the current frame are short for the preprocessed left channel time-domain signal of the current frame and the preprocessed right channel time-domain signal of the current frame. High-pass filtering may be performed by an infinite impulse response (IIR) filter whose cut-off frequency is 20 hertz (Hz), or may be performed by a filter of another type. For example, a transfer function of a high-pass filter whose sampling rate is 16 KHz and that corresponds to a cut-off frequency of 20 Hz is:

$${H}_{20 Hz} ( z ) = \frac{{b}_{0} + {b}_{1} {z}^{- 1} + {b}_{2} {z}^{- 2}}{1 + {a}_{1} {z}^{- 1} + {a}_{2} {z}^{- 2}} ;$$

where b₀=0.994461788958195, b₁=−1.988923577916390, b₂=0.994461788958195, a₁=1.988892905899653, a₂=−0.988954249933127, and z is a transform factor in Z transform domain.

A corresponding time-domain filter is as follows:

x_{L_HP}(n)=b₀*x_{L}(n)+b₁*x_{L}(n−1)+b₂*x_{L}(n−2)−a₁*x_{L_HP}(n−1)−a₂*x_{L_HP}(n−2).

It may be understood that performing time-domain preprocessing on the left and right channel time-domain signals of the current frame is not a necessary step. If there is no time-domain preprocessing step, left and right channel signals used for delay estimation are left and right channel signals in the original stereo signal. Herein, the left and right channel signals in the original stereo signal refer to a pulse-code modulation (PCM) signal obtained after analog-to-digital conversion. A sampling rate of the signal may include 8 KHz, 16 KHz, 32 KHz, 44.1 KHz, and 48 KHz.

In addition, in addition to the high-pass filtering described in this embodiment, the preprocessing may further include other processing, for example, pre-emphasis processing. This is not limited in this embodiment of this application.

S02: Perform time-domain analysis based on the preprocessed left and right channel signals.

Specifically, the time-domain analysis may include transient detection and the like. The transient detection may be separately performing energy detection on the preprocessed left and right channel time-domain signals of the current frame, for example, detecting whether a sudden energy change occurs in the current frame. For example, energy E_{cur_L} of the preprocessed left channel time-domain signal of the current frame is calculated, and transient detection is performed based on an absolute value of a difference between energy E_{pre_L} of a preprocessed left channel time-domain signal of a previous frame and the energy E_{cur_L} of the preprocessed left channel time-domain signal of the current frame, to obtain a transient detection result of the preprocessed left channel time-domain signal of the current frame. Similarly, the same method may be used to perform transient detection on the preprocessed right channel time-domain signal of the current frame. The time-domain analysis may include other time-domain analysis in addition to transient detection, for example, may include determining a time-domain inter-channel time difference (ITD) parameter, delay alignment processing in time domain, and frequency band extension preprocessing.

S03: Perform time-frequency transform on the preprocessed left and right channel signals, to obtain left and right channel frequency-domain signals.

Specifically, discrete Fourier transform may be performed on the preprocessed left channel signal to obtain the left channel frequency-domain signal, and discrete Fourier transform may be performed on the preprocessed right channel signal to obtain the right channel frequency-domain signal. To overcome a problem of spectral aliasing, an overlap-add method may be used for processing between two consecutive times of discrete Fourier transform, and sometimes, zero may be added to an input signal of discrete Fourier transform.

Discrete Fourier transform may be performed once per frame. Alternatively, each frame of signal may be divided into P subframes, and discrete Fourier transform is performed once per subframe. If discrete Fourier transform is performed once per frame, the transformed left channel frequency-domain signal may be denoted as L(k), where k=0, 1, . . . , L/2−1, and L represents a sampling point; and the transformed right channel frequency-domain signal may be denoted as R(k), where k=0, 1 . . . , L/2−1, and k is a frequency bin index value. If discrete Fourier transform is performed once per subframe, a transformed left channel frequency-domain signal of the i^{th} subframe may be denoted as Lᵢ(k), where k=0, 1, . . . , L/2−1; and a transformed right channel frequency-domain signal of the i^{th} subframe may be denoted as Rᵢ(k), where k=0, 1, . . . , L/2−1, k is a frequency bin index value, i is a subframe index value, and i=0, 1, . . . , P−1. For example, in this embodiment, wideband is used as an example. The wideband means that an encoding bandwidth may be 8 KHz or greater, each frame of left channel signal or each frame of right channel signal is 20 ms, and a frame length is denoted as N. In this case, N=320, that is, the frame length is 320 sampling points. Each frame of signal is divided into two subframes, that is, P=2. Each subframe of signal is 10 ms, and a subframe length is 160 sampling points. Discrete Fourier transform is performed once per subframe. A length of the discrete Fourier transform is denoted as L, and L=400, that is, the length of the discrete Fourier transform is 400 sampling points. In this case, a transformed left channel frequency-domain signal of the i^{th} subframe may be denoted as Lᵢ(k), where k=0, 1, . . . , L/2−1; and a transformed right channel frequency-domain signal of the i^{th} subframe may be denoted as Rᵢ(k), where k=0, 1, . . . , L/2−1, k is a frequency bin index value, i is a subframe index value, and i=0, 1, . . . , P−1.

S04: Determine an ITD parameter, and encode the ITD parameter.

There are a plurality of methods for determining the ITD parameter. The ITD parameter may be determined only in frequency domain, may be determined only in time domain, or may be determined in time-frequency domain. This is not limited in this application.

For example, the ITD parameter may be extracted in time domain by using a cross-correlation coefficient between the left and right channels. For example, in a range of 0≤i≤Tmax,

$${c}_{n} ( i ) = {\sum }_{j = 0}^{N - 1 - i} {x}_{R \_ HP} ( j ) \cdot {x}_{L \_ HP} ( j + i ) and {c}_{p} ( i ) = {\sum }_{j = 0}^{N - 1 - i} {x}_{L \_ HP} ( j ) \cdot {x}_{R \_ HP} ( j + i )$$

are calculated. If

$${max}_{0 \leq i \leq T max} ( {c}_{n} ( i ) ) > {max}_{0 \leq i \leq T max} ( {c}_{p} ( i ) ) ,$$

the ITD parameter value is an inverse number of an index value corresponding to max(Cn(i)), where an index table corresponding to the max(Cn(i)) value is specified in the codec by default; otherwise, the ITD parameter value is an index value corresponding to max(Cp(i)).

Herein, i is an index value for calculating the cross-correlation coefficient, j is an index value of a sampling point, Tmax corresponds to a maximum value of ITD values at different sampling rates, and N is a frame length. The ITD parameter may alternatively be determined in frequency domain based on the left and right channel frequency-domain signals. For example, time-frequency transform technologies such as discrete Fourier transform (DFT), fast Fourier transform (FFT), and modified discrete cosine transform (MDCT) may be used to transform a time-domain signal into a frequency-domain signal. In this embodiment, a DFT-transformed left channel frequency-domain signal of the i^{th} subframe is Lᵢ(k), where k=0, 1, . . . , L/2−1, and a transformed right channel frequency-domain signal of the i^{th} subframe is Rᵢ(k), where k=0, 1, . . . , L/2−1, and i=0, 1, . . . , P−1. A frequency-domain correlation coefficient XCORRᵢ(k)=Lᵢ(k)*R*ᵢ(k) of the i^{th} subframe is calculated. R*ᵢ(k) is a conjugate of the time-frequency transformed right channel frequency-domain signal of the i^{th} subframe. The frequency-domain cross-correlation coefficient is transformed to time domain xcorrᵢ(n), where n=0, 1, . . . , L−1, and a maximum value of xcorrᵢ(n) is searched for in a range of L/2−Tₘₐₚ≤n≤L/2+Tₘₐₓ, to obtain an ITD parameter value

$${T}_{i} = arg {max}_{L \text{/} 2 - {T}_{max} \leq n \leq L \text{/} 2 + {T}_{max}} ( {xcorr}_{i} ( n ) ) - \frac{L}{2}$$

of the i^{th} subframe.

For another example, a magnitude value:

$$mag ( j ) = {\sum }_{i = 0}^{1} {\sum }_{k = 0}^{L \text{/} 2 - 1} {L}_{i} ( k ) * {R}_{i} ( k ) * exp ( \frac{2 π * k * j}{L} )$$

may be calculated within a search range of −Tₘₐₓ≤j≤Tₘₐₓ based on the DFT-transformed left channel frequency-domain signal of the i^{th} subframe and the DFT-transformed right channel frequency-domain signal of the i^{th} subframe, and the ITD parameter value is

$$T = arg {max}_{- {T}_{max} \leq j \leq {T}_{max}} ( mag ( j ) ) ,$$

that is an index value corresponding to a maximum magnitude value.

After the ITD parameter is determined, residual encoding and entropy encoding need to be performed on the ITD parameter in the encoder, and then the ITD parameter is written into a stereo encoded bitstream.

S05: Perform time shifting adjustment on the left and right channel frequency-domain signals based on the ITD parameter.

In this embodiment of this application, time shifting adjustment is performed on the left and right channel frequency-domain signals in a plurality of manners, which are described in the following with examples.

In this embodiment, an example in which each frame of signal is divided into P subframes, and P=2 is used. A left channel frequency-domain signal of the i^{th} subframe after time shifting adjustment may be denoted as L′ᵢ(k), where k=0, 1, . . . , L/2−1. A right channel frequency-domain signal of the i^{th} subframe after time shifting adjustment may be denoted as g(k), where k=0, 1, . . . , L/2−1, k is a frequency bin index value, and i=0, 1, . . . , P−1.

$${L}_{i}^{′} ( k ) = {L}_{i} ( k ) * {e}^{- j 2 π \frac{{τ}_{i}}{L}}$$

$${R}_{i}^{′} ( k ) = {R}_{i} ( k ) * {e}^{- j 2 π \frac{{τ}_{i}}{L}} ;$$

where τᵢ is an ITD parameter value of the i^{th} subframe, L is a length of the discrete Fourier transform, Lᵢ(k) is a time-frequency transformed left channel frequency-domain signal of the i^{th} subframe, Rᵢ(k) is a transformed right channel frequency-domain signal of the i^{th} subframe, i is a subframe index value, and i=0, 1, . . . , P−1.

It may be understood that, if DFT is not performed through frame division, the time shifting adjustment may be performed once for an entire frame. After frame division, time shifting adjustment is performed based on each subframe. If frame division is not performed, time shifting adjustment is performed based on each frame.

S06: Calculate other frequency-domain stereo parameters, and perform encoding.

The other frequency-domain stereo parameters may include but are not limited to: an inter-channel phase difference (IPD) parameter, an inter-channel level difference (ILD) (also referred to as an inter-channel amplitude difference) parameter, a subband side gain, and the like. This is not limited in this embodiment of this application. After the other frequency-domain stereo parameters are obtained through calculation, residual encoding and entropy encoding need to be performed on the other frequency-domain stereo parameters, and then the other frequency-domain stereo parameters are written into the stereo encoded bitstream.

S07: Calculate a primary channel signal and a secondary channel signal.

The primary channel signal and the secondary channel signal are calculated. Specifically, any time-domain downmix processing or frequency-domain downmix processing method in the embodiments of this application may be used. For example, the primary channel signal and the secondary channel signal of the current frame may be calculated based on the left channel frequency-domain signal of the current frame and the right channel frequency-domain signal of the current frame. A primary channel signal and a secondary channel signal of each subband corresponding to a preset low frequency band of the current frame may be calculated based on a left channel frequency-domain signal of each subband corresponding to the preset low frequency band of the current frame and a right channel frequency-domain signal of each subband corresponding to the preset low frequency band of the current frame. Alternatively, a primary channel signal and a secondary channel signal of each subframe of the current frame may be calculated based on a left channel frequency-domain signal of each subframe of the current frame and a right channel frequency-domain signal of each subframe of the current frame. Alternatively, a primary channel signal and a secondary channel signal of each subband corresponding to a preset low frequency band in each subframe of the current frame may be calculated based on a left channel frequency-domain signal of each subband corresponding to the preset low frequency band in each subframe of the current frame and a right channel frequency-domain signal of each subband corresponding to the preset low frequency band in each subframe of the current frame. The primary channel signal may be obtained by adding the left channel time-domain signal of the current frame and the right channel time-domain signal of the current frame, and the secondary channel signal may be obtained by calculating a difference between the left channel time-domain signal and the right channel time-domain signal.

In this embodiment, because frame division processing is performed on each frame of signal, a primary channel signal and a secondary channel signal of each subframe are transformed to time domain through inverse transform of discrete Fourier transform, and overlap-add processing is performed, to obtain a time-domain primary channel signal and secondary channel signal of the current frame.

It should be noted that a process of obtaining the primary channel signal and the secondary channel signal in step S07 is referred to as downmix processing, and starting from step S08, the primary channel signal and the secondary channel signal are processed.

S08: Encode the downmixed primary channel signal and secondary channel signal.

Specifically, bit allocation may be first performed for encoding of the primary channel signal and encoding of the secondary channel signal based on parameter information obtained in encoding of a primary channel signal and a secondary channel signal in the previous frame and a total quantity of bits for encoding the primary channel signal and the secondary channel signal. Then, the primary channel signal and the secondary channel signal are separately encoded based on a result of bit allocation. Primary channel signal encoding and secondary channel signal encoding may be implemented by using any mono audio encoding technology. For example, an algebraic code-excited linear prediction (ACELP) encoding method is used to encode the primary channel signal and the secondary channel signal that are obtained through downmix processing. The ACELP encoding method generally includes: determining a linear prediction coefficient (LPC) and transforming the linear prediction coefficient into a line spectral frequency (LSF) for quantization and encoding; searching for an adaptive code excitation to determine a pitch period and an adaptive codebook gain, and performing quantization and encoding on the pitch period and the adaptive codebook gain separately; and searching for an algebraic code excitation to determine a pulse index and a gain of the algebraic code excitation, and performing quantization and encoding on the pulse index and the gain of the algebraic code excitation separately.

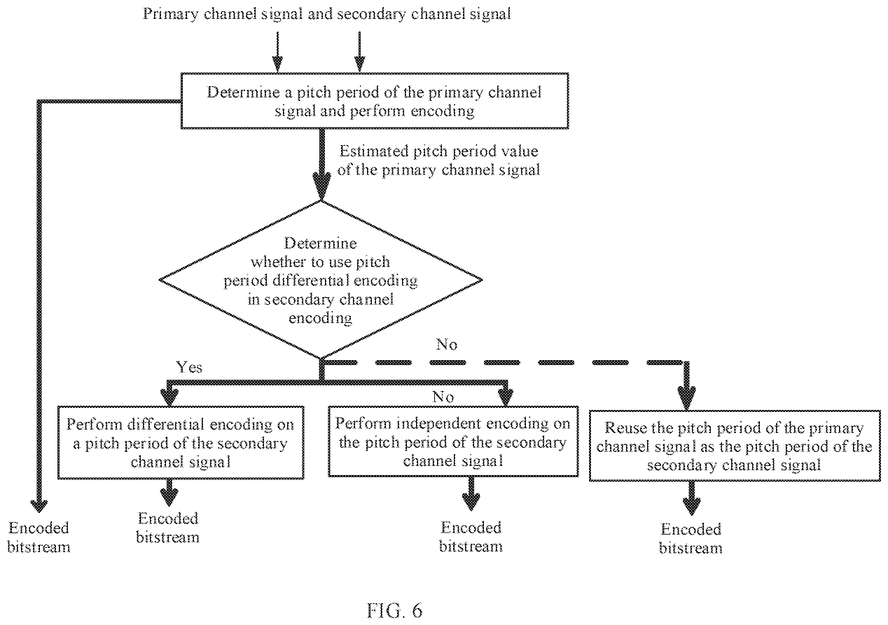

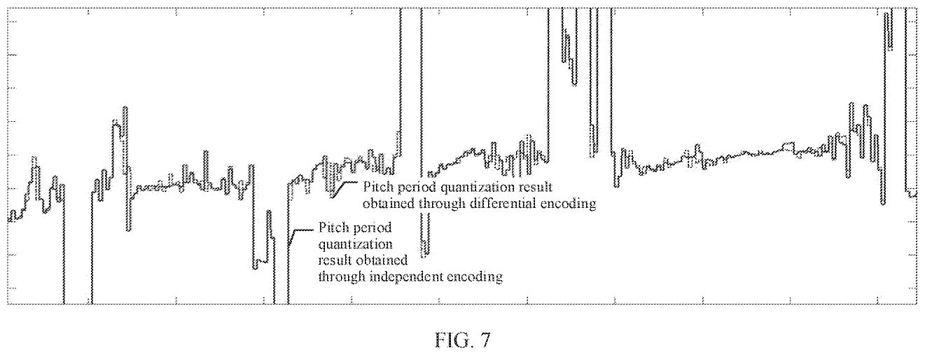

FIG. 6 is a flowchart of encoding a pitch period parameter of a primary channel signal and a pitch period parameter of a secondary channel signal according to an embodiment of this application. The process shown in FIG. 6 includes the following steps S09 to S12. A process of encoding the pitch period parameter of the primary channel signal and the pitch period parameter of the secondary channel signal is as follows:

S09: Determine a pitch period of the primary channel signal and perform encoding.

Specifically, during encoding of the primary channel signal, pitch period estimation is performed through a combination of open-loop pitch analysis and closed-loop pitch search, so as to improve accuracy of pitch period estimation. A pitch period of a speech may be estimated by using a plurality of methods, for example, using an autocorrelation function, or using a short-term average amplitude difference. A pitch period estimation algorithm is based on the autocorrelation function. The autocorrelation function has a peak at an integer multiple of a pitch period, and this feature can be used to estimate the pitch period. In order to improve accuracy of pitch prediction and approximate an actual pitch period of speech better, a fractional delay with a sampling resolution of ⅓ is used for pitch period detection. In order to reduce a computation amount of pitch period estimation, pitch period estimation includes two steps: open-loop pitch analysis and closed-loop pitch search. Open-loop pitch analysis is used to roughly estimate an integer delay of a frame of speech to obtain a candidate integer delay. Closed-loop pitch search is used to finely estimate a pitch delay in the vicinity of the integer delay, and closed-loop pitch search is performed once per subframe. Open-loop pitch analysis is performed once per frame, to compute autocorrelation, normalization, and an optimum open-loop integer delay.

An estimated pitch period value of the primary channel signal that is obtained through the foregoing steps is used as a pitch period encoding parameter of the primary channel signal and is further used as a pitch period reference value of the secondary channel signal.

S10: Determine whether to use pitch period differential encoding in secondary channel encoding.

In secondary channel encoding, a secondary channel pitch period differential encoding decision is performed based on the estimated pitch period value of the primary channel and an estimated open-loop pitch period value of the secondary channel signal, where a decision condition is:

DIFF=|Σ(pitch[0])−Σ(pitch[1])|,

where DIFF represents a difference between the estimated pitch period value of the primary channel signal and the estimated open-loop pitch period value of the secondary channel signal. |Σ(pitch[0])−Σ(pitch[1])| represents an absolute value of the difference between Σ(pitch[0]) and Σ(pitch[1]). Σ(pitch[0]) represents the estimated pitch period value of the primary channel signal, and Σ(pitch[1]) represents the estimated open-loop pitch period value of the secondary channel signal.

A secondary channel pitch period differential encoding flag is indicated by Pitch_reuse_flag. DIFF_THR is a preset secondary channel pitch period differential encoding threshold. It is determined, based on different encoding rates, that the secondary channel pitch period differential encoding threshold is a specific value in {1, 3, 6}. For example, when DIFF>DIFF_THR, Pitch_reuse_flag=1, and it is determined that pitch period differential encoding for the secondary channel signal is used in the current frame. When DIFF≤DIFF_THR, Pitch_reuse_flag=0. In this case, pitch period differential encoding is not performed, and independent encoding for the secondary channel signal is used.

S11: If pitch period differential encoding is not performed, encode a pitch period of the secondary channel signal by using a pitch period independent encoding method for the secondary channel signal.

If pitch period differential encoding for the secondary channel signal is not used, a pitch period reusing method for the secondary channel signal may be used, that is, the pitch period of the secondary channel signal is not encoded on the encoder side, and a decoder side uses the pitch period of the primary channel signal as the pitch period of the secondary channel signal for decoding. This is not limited.

S12: Perform differential encoding on the pitch period of the secondary channel signal.

Specific steps of performing differential encoding on the pitch period of the secondary channel signal include:

S121: Perform secondary channel signal closed-loop pitch period search based on the estimated pitch period value of the primary channel signal, to obtain an estimated pitch period value of the secondary channel signal.

S12101: Determine a closed-loop pitch period reference value of the secondary channel signal based on the estimated pitch period value of the primary channel signal.

In this embodiment, an encoding rate of 24.4 kbps is used as an example. Pitch period encoding is performed based on subframes, the primary channel signal is divided into five subframes, and the secondary channel signal is divided into four subframes. The pitch period reference value of the secondary channel signal is determined based on the pitch period of the primary channel signal. One method is to directly use the pitch period of the primary channel signal as the pitch period reference value of the secondary channel signal. That is, four values are selected from pitch periods of the five subframes of the primary channel signal as pitch period reference values of the four subframes of the secondary channel signal. In another method, the pitch periods of the five subframes of the primary channel signal are mapped to pitch period reference values of the four subframes of the secondary channel signal by using an interpolation method. According to either of the foregoing methods, the closed-loop pitch period reference value of the secondary channel signal can be obtained, where an integer part is loc_T0, and a fractional part is loc_frac_prim.

S12102: Perform secondary channel signal closed-loop pitch period search based on the pitch period reference value of the secondary channel signal, to determine the pitch period of the secondary channel signal. Specifically, closed-loop pitch period search is performed by using integer precision and downsampling fractional precision and by using the closed-loop pitch period reference value of the secondary channel signal as a start point of the secondary channel signal closed-loop pitch period search, and an interpolated normalized correlation is computed to obtain the estimated pitch period value of the secondary channel signal.

For example, one method is to use 2 bits (bits) for encoding of the pitch period of the secondary channel signal, which is specifically:

Integer precision search is performed, by using loc_T0 as a search start point, for the pitch period of the secondary channel signal within a range of [loc_T0−1, loc_T0+1], and then fractional precision search is performed, by using loc_frac_prim as an initial value for each search point, for the pitch period of the secondary channel signal within a range of [loc_frac_prim+2, loc_frac_prim+3], [loc_frac_prim, loc_frac_prim−3], or [loc_frac_prim−2, loc_frac_prim+1]. An interpolated normalized correlation corresponding to each search point is computed, and a similarity of a plurality of search points in one frame is computed. When a maximum value of an interpolated normalized correlation is obtained, the search point corresponding to the interpolated normalized correlation is an optimum estimated pitch period value of the secondary channel signal, where an integer part is pitch_soft_reuse, and a fractional part is pitch_frac_soft_reuse.

For another example, another method is to use 3 bits to 5 bits to encode the pitch period of the secondary channel signal, which is specifically:

When 3 bits to 5 bits are used to encode the pitch period of the secondary channel signal, search radiuses half range are 1, 2, and 4 respectively. Integer precision search is performed, by using loc_T0 as a search start point, for the pitch period of the secondary channel signal within a range of [loc_T0−half_range, loc_T0+half range], and then an interpolated normalized correlation corresponding to each search point is computed, by using loc_frac_prim as an initial value for each search point, within a range of [loc_frac_prim, loc_frac_prim−1], or [loc_frac_prim, loc_frac_prim+3]. When a maximum value of an interpolated normalized correlation is obtained, the search point corresponding to the interpolated normalized correlation is an optimum estimated pitch period value of the secondary channel signal, where an integer part is pitch_soft_reuse, and a fractional part is pitch_frac_soft_reuse.

S122: Perform differential encoding by using the pitch period of the primary channel signal and the pitch period of the secondary channel signal. Specifically, the following process may be included.

S1221: Calculate an upper limit of a pitch period index of the secondary channel signal in differential encoding.

The upper limit of the pitch period index of the secondary channel signal is calculated by using the following formula:

soft_reuse_index_high_limit=2^{Z};

where Z is a pitch period search range adjustment factor of the secondary channel. In this embodiment, Z=3, 4, or 5.

S1222: Calculate the pitch period index value of the secondary channel signal in differential encoding.

The pitch period index of the secondary channel signal represents a result of performing differential encoding on a difference between the pitch period reference value of the secondary channel signal obtained in the foregoing step and the optimum estimated pitch period value of the secondary channel signal.

The pitch period index value soft_reuse_index of the secondary channel signal is calculated by using the following formula:

soft_reuse_index=(4*pitch_soft_reuse+pitch_frac_soft_reuse)−(4*loc_T0+loc_frac_prim)+soft_reuse_index_high_limit/2.

S1223: Perform differential encoding on the pitch period index of the secondary channel signal.

For example, residual encoding is performed on the pitch period index soft_reuse_index of the secondary channel signal.

In this embodiment of this application, a pitch period encoding method for the secondary channel signal is used. Each coded frame is divided into four subframes (subframe), and differential encoding is performed on a pitch period of each subframe. The method can save 22 bits or 18 bits compared with pitch period independent encoding for the secondary channel signal, and the saved bits may be allocated to other encoding parameters for quantization and encoding. For example, the saved bit overheads may be allocated to a fixed codebook (fixed codebook).

Encoding of other parameters of the primary channel signal and the secondary channel signal is completed by using this embodiment of this application, to obtain encoded bitstreams of the primary channel signal and the secondary channel signal, and the encoded data is written into a stereo encoded bitstream based on a specific bitstream format requirement.

The following describes an effect of reducing encoding overheads of the secondary channel signal in this embodiment of this application by using an example. For a pitch period independent encoding scheme for the secondary channel signal, quantities of pitch period encoding bits allocated to four subframes are respectively 10, 6, 9, and 6. That is, 31 bits are required for encoding each frame. However, according to the differential encoding method oriented to the pitch period of the secondary channel signal provided in this embodiment of this application, only three bits are required for differential encoding in each subframe, and one bit is further required to indicate whether differential encoding is performed on the pitch period of the secondary channel signal (a value of the one bit may be 0 or 1; for example, when the value is 1, differential encoding needs to be performed, or when the value is 0, differential encoding is not performed). Therefore, according to the method in this embodiment of this application, only 31-4×3=13 bits are required for each frame to encode the pitch period of the secondary channel signal. That is, 18 bits may be saved and allocated to other encoding parameters, such as fixed codebook parameters.

FIG. 8 is a diagram of comparison between a quantity of bits allocated to a fixed codebook after an independent encoding scheme is used and a quantity of bits allocated to a fixed codebook after a differential encoding scheme is used. The solid line indicates a quantity of bits allocated to the fixed codebook after independent encoding, and the dashed line indicates a quantity of bits allocated to the fixed codebook after differential encoding. It can be learned from FIG. 8 that a large quantity of bit resources saved by using the differential encoding oriented to the pitch period of the secondary channel signal are allocated for quantization and encoding of the fixed codebook, so that encoding quality of the secondary channel signal is improved.

The following describes a stereo decoding algorithm executed by the decoder side by using an example, and the following procedure is mainly performed.

S13: Read Pitch_reuse_flag from a bitstream.

S14: When the following condition is met: an encoding rate of a secondary channel signal is relatively low and Pitch_reuse_flag=1, perform pitch period differential decoding for the secondary channel signal; otherwise, perform pitch period independent decoding for the secondary channel signal.

When the following condition is not met: the encoding rate of the secondary channel signal is relatively low and Pitch_reuse_flag=1, a secondary channel signal pitch period reuse flag may be used to indicate that a pitch period of the secondary channel signal reuses an estimated pitch period value of a primary channel signal. This is not limited. In this case, the decoder side may use the pitch period of the primary channel signal as the pitch period of the secondary channel signal for decoding based on the secondary channel signal pitch period reuse flag.

For example, the secondary channel pitch period differential encoding flag is indicated by Pitch_reuse_flag. DIFF_THR is a preset secondary channel pitch period differential encoding threshold. It is determined, based on different encoding rates, that the secondary channel pitch period differential encoding threshold is a specific value in {1, 3, 6}. For example, when DIFF>DIFF_THR, Pitch_reuse_flag=1, and it is determined that pitch period differential encoding for the secondary channel signal is used in a current frame. When DIFF≤DIFF_THR, Pitch_reuse_flag=0. In this case, pitch period differential encoding is not performed, and independent encoding for the secondary channel signal is used.

S1401: Perform pitch period mapping.

In this embodiment, pitch period encoding is performed based on subframes, the primary channel is divided into five subframes, and the secondary channel is divided into four subframes. A pitch period reference value of the secondary channel is determined based on the estimated pitch period value of the primary channel signal. One method is to directly use the pitch period of the primary channel as the pitch period reference value of the secondary channel. That is, four values are selected from pitch periods of the five subframes of the primary channel as pitch period reference values of the four subframes of the secondary channel. In another method, the pitch periods of the five subframes of the primary channel are mapped to pitch period reference values of the four subframes of the secondary channel by using an interpolation method. According to either of the foregoing methods, an integer part loc_T0 and a fractional part loc_frac_prim of a closed-loop pitch period of the secondary channel signal can be obtained.

S1402: Calculate a closed-loop pitch period reference value of the secondary channel.

The closed-loop pitch period reference value f_pitch_prim of the secondary channel is calculated by using the following formula:

f_pitch_prim=loc_T0+loc_frac_prim/4.0

S1403: Calculate an upper limit of a pitch period index of the secondary channel in differential encoding.

The upper limit of the pitch period index of the secondary channel is calculated by using the following formula:

soft_reuse_index_high_limit=0.5+2^{Z};

where Z is a pitch period search range adjustment factor of the secondary channel. In this embodiment, Z may be 3, 4, or 5.

S1404: Read the pitch period index value soft_reuse_index of the secondary channel from the bitstream.

S1405: Calculate an estimated pitch period value of the secondary channel signal.

T0_pitch=f_pitch_prim+(soft_reuse_index−soft_reuse_index_high_limit/2.0)/4.0;

where T0=INT(T0_pitch), and T0_frac=(T0_pitch−T0)*4.0.

INT(T0_pitch) indicates to round down T0_pitch to the nearest integer, T0 indicates to decode the integer part of the estimated pitch period value of the secondary channel, and T0_frac indicates to decode the fractional part of the estimated pitch period value of the secondary channel.

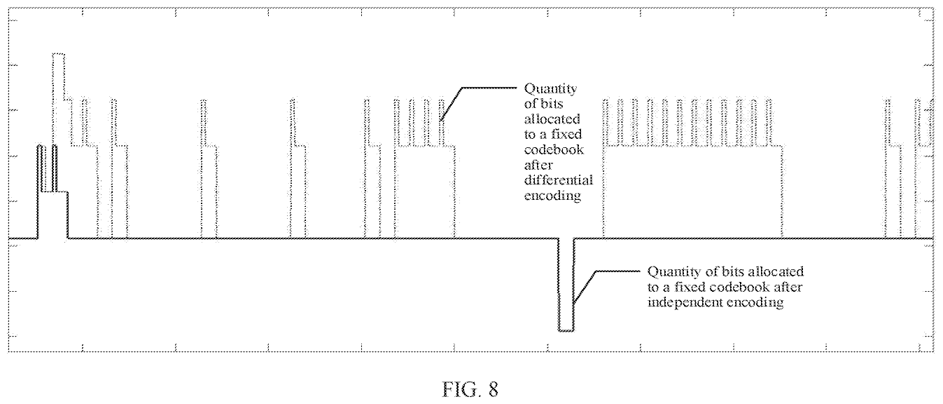

The stereo encoding and decoding processes in frequency domain are described in the foregoing embodiments. When the embodiments of this application are applied to time-domain stereo encoding, steps S01 to S07 in the foregoing embodiment are replaced by the following steps S21 to S26. FIG. 9 is a schematic diagram of a time-domain stereo encoding method according to an embodiment of this application.

S21: Perform time-domain preprocessing on a stereo time-domain signal to obtain preprocessed stereo left and right channel signals.

If a sampling rate of a stereo audio signal is 16 KHz, one frame of signal is 20 ms, and a frame length is denoted as N, N=320, that is, the frame length is equal to 320 sampling points. A stereo signal of a current frame includes a left channel time-domain signal of the current frame and a right channel time-domain signal of the current frame. The left channel time-domain signal of the current frame is denoted as x_{L}(n), and the right channel time-domain signal of the current frame is denoted as x_{R}(n), where n is a sampling point number, and n=0, 1, . . . , N−1.

Performing time-domain preprocessing on the left and right channel time-domain signals of the current frame may specifically include: performing high-pass filtering on the left and right channel time-domain signals of the current frame, to obtain preprocessed left and right channel time-domain signals of the current frame. The preprocessed left channel time-domain signal of the current frame is denoted as \tilde{x}_{L}(n), and the preprocessed right channel time-domain signal of the current frame is denoted as \tilde{x}_{R}(n), where n is a sampling point number, and n=0, 1, . . . , N−1.

It may be understood that performing time-domain preprocessing on the left and right channel time-domain signals of the current frame is not a necessary step. If there is no time-domain preprocessing step, left and right channel signals used for delay estimation are left and right channel signals in the original stereo signal. The left and right channel signals in the original stereo signal refer to a collected PCM signal obtained after A/D conversion. A sampling rate of the signal may include 8 KHz, 16 KHz, 32 KHz, 44.1 KHz, and 48 KHz.

In addition, in addition to the high-pass filtering described in this embodiment, the preprocessing may further include other processing, for example, pre-emphasis processing. This is not limited in this embodiment of this application.

S22: Perform delay estimation based on the preprocessed left and right channel time-domain signals of the current frame, to obtain an estimated inter-channel delay difference of the current frame.

Specifically, a cross-correlation function between the left and right channels may be calculated based on the preprocessed left and right channel time-domain signals of the current frame. Then, a maximum value of the cross-correlation function is searched for as the estimated inter-channel delay difference of the current frame.

It is assumed that Tₘₐₓ corresponds to a maximum value of the inter-channel delay difference at a current sampling rate, and Tₘᵢₙ corresponds to a minimum value of the inter-channel delay difference at the current sampling rate. Tₘₐₓ and Tran are preset real numbers, and Tₘₐₓ>Tₘᵢₙ. In this embodiment, Tₘₐₓ is equal to 40, Tₘᵢₙ is equal to −40, a maximum value of a cross-correlation coefficient c(i) between the left and right channels is searched for within a range of Tₘᵢₙ≤i≤Tₘₐₓ, to obtain an index value corresponding to the maximum value, and the index value is used as the estimated inter-channel delay difference of the current frame, and is denoted as cur_itd.

There are many other specific delay estimation methods in this embodiment of this application. This is not limited. For example, the cross-correlation function between the left and right channels may be calculated based on the preprocessed left and right channel time-domain signals of the current frame or based on the left and right channel time-domain signals of the current frame. Then, long-time smoothing is performed based on a cross-correlation function between left and right channels of the previous L frames (L is an integer greater than or equal to 1) and the calculated cross-correlation function between the left and right channels of the current frame, to obtain a smoothed cross-correlation function between the left and right channels. Then, a maximum value of a smoothed cross-correlation coefficient between the left and right channels is searched for within a range of Tₘᵢₙ≤i≤Tₘₐₓ, to obtain an index value corresponding to the maximum value, and the index value is used as the estimated inter-channel delay difference of the current frame. The methods may further include: performing inter-frame smoothing on an inter-channel delay difference of the previous M frames (M is an integer greater than or equal to 1) and an estimated inter-channel delay difference of the current frame, and using a smoothed inter-channel delay difference as the final estimated inter-channel delay difference of the current frame. This embodiment of this application is not limited to the foregoing delay estimation methods.

For the estimated inter-channel delay difference of the current frame, a maximum value of the cross-correlation coefficient c(i) between the left and right channels is searched for within the range of Tₘᵢₙ≤i≤Tₘₐₓ, to obtain an index value corresponding to the maximum value.

S23: Perform delay alignment on the stereo left and right channel signals based on the estimated inter-channel delay difference of the current frame, to obtain a delay-aligned stereo signal.

In this embodiment of this application, there are many methods for performing delay alignment on the stereo left and right channel signals. For example, one or two channels of the stereo left and right channel signals are compressed or stretched based on the estimated inter-channel delay difference of the current frame and an inter-channel delay difference of a previous frame, so that no inter-channel delay difference exists in the two signals of the delay-aligned stereo signal. This embodiment of this application is not limited to the foregoing delay alignment method.

A delay-aligned left channel time-domain signal of the current frame is denoted as x′_{L}(n), and a delay-aligned right channel time-domain signal of the current frame is denoted as x′_{R}(n), where n is a sampling point number, and n=0, 1, . . . , N−1.

S24: Quantize and encode the estimated inter-channel delay difference of the current frame.

There may be a plurality of methods for quantizing the inter-channel delay difference. For example, quantization processing is performed on the estimated inter-channel delay difference of the current frame, to obtain a quantized index, and then the quantized index is encoded. The quantized index is written into a bitstream after being quantized.

S25: Calculate a channel combination ratio factor based on the delay-aligned stereo signal, perform quantization and encoding on the channel combination ratio factor, and write a quantized and encoded result into the bitstream.

There are many methods for calculating the channel combination ratio factor. For example, in a method for calculating the channel combination ratio factor in this embodiment of this application, frame energy of the left and right channels is first calculated based on the delay-aligned left and right channel time-domain signals of the current frame.

The frame energy rms_L of the left channel of the current frame meets:

$$rms\_L = \frac{1}{N} {\sum }_{i = 0}^{N - 1} {x}_{L}^{′} ( i ) * {x}_{L}^{′} ( i ) ,$$

and the frame energy rms_R of the right channel of the current frame meets:

$$rms\_R = \frac{1}{N} {\sum }_{i = 0}^{N - 1} {x}_{R}^{′} ( i ) * {x}_{R}^{′} ( i ) ,$$

where x′_{L}(n) is the delay-aligned left channel time-domain signal of the current frame, and x′_{R}(n) is the delay-aligned right channel time-domain signal of the current frame.

Then, the channel combination ratio factor of the current frame is calculated based on the frame energy of the left and right channels.

The calculated channel combination ratio factor ratio of the current frame meets:

$$ratio = \frac{rms\_R}{rms\_L + rms\_R} .$$

Finally, the calculated channel combination ratio factor of the current frame is quantized, to obtain a quantized index ratio_idx corresponding to the ratio factor and a quantized channel combination ratio factor ratio_{qua} of the current frame:

ratio_{qua}=ratio_tabl[ratio_idx],

where ratio_tabl is a scalar quantization codebook. Quantization and encoding may be performed by using any scalar quantization method in the embodiments of this application, for example, uniform scalar quantization or non-uniform scalar quantization. A quantity of bits used for encoding may be 5 bits. A specific method is not described herein.

This embodiment of this application is not limited to the foregoing channel combination ratio factor calculation, quantization, and encoding method.

S26: Perform time-domain downmix processing on the delay-aligned stereo signal based on the channel combination ratio factor, to obtain a primary channel signal and a secondary channel signal.

Specifically, any time-domain downmix processing method in the embodiments of this application may be used. However, it should be noted that a corresponding time-domain downmix processing manner needs to be selected based on a method for calculating the channel combination ratio factor, to perform time-domain downmix processing on the delay-aligned stereo signal, to obtain the primary channel signal and the secondary channel signal.

For example, the foregoing method for calculating the channel combination ratio factor in step 25 is used, and corresponding time-domain downmix processing may be: performing time-domain downmix processing based on the channel combination ratio factor ratio. A primary channel signal Y(n) and a secondary channel signal X(n) that are obtained after time-domain downmix processing corresponding to a first channel combination solution meet:

$$[ \begin{matrix}Y ( n ) \\ X ( n )\end{matrix} ] = [ \begin{matrix}ratio & 1 - ratio \\ 1 - ratio & - ratio\end{matrix} ] * [ \begin{matrix}{x}_{L}^{′} ( n ) \\ {x}_{R}^{′} ( n )\end{matrix} ] .$$

This embodiment of this application is not limited to the foregoing time-domain downmix processing method.

S27: Perform differential encoding on the secondary channel signal.

For content included in step S27, refer to descriptions of step S10 to step S12 in the foregoing embodiment. Details are not described herein again.

It can be learned from the foregoing examples that, in this embodiment of this application, whether to use differential encoding of the pitch period of the secondary channel signal is determined, and in the differential encoding manner, encoding overheads of the pitch period of the secondary channel signal can be reduced.

It should be noted that, for brief description, the foregoing method embodiments are represented as a combination of a series of actions. However, a person skilled in the art should appreciate that this application is not limited to the described order of the actions, because according to this application, some steps may be performed in other orders or simultaneously.

To better implement the foregoing solutions in the embodiments of this application, the following further provides related apparatuses configured to implement the foregoing solutions.

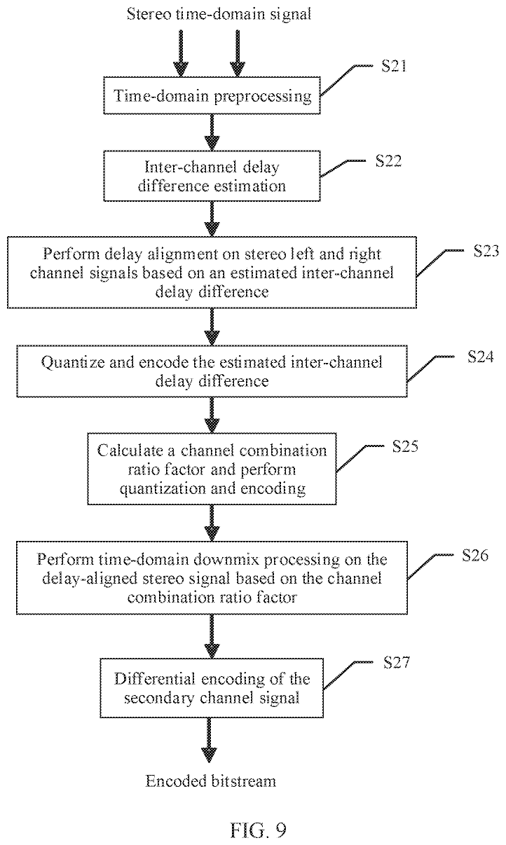

As shown in FIG. 10, a stereo encoding apparatus 1000 provided in an embodiment of this application may include a downmix module 1001, a determining module 1002, and a differential encoding module 1003.

The downmix module 1001 is configured to perform downmix processing on a left channel signal of a current frame and a right channel signal of the current frame, to obtain a primary channel signal of the current frame and a secondary channel signal of the current frame.

The determining module 1002 is configured to determine whether to perform differential encoding on a pitch period of the secondary channel signal.

The differential encoding module 1003 is configured to: when it is determined to perform differential encoding on the pitch period of the secondary channel signal, perform differential encoding on the pitch period of the secondary channel signal by using an estimated pitch period value of the primary channel signal, to obtain a pitch period index value of the secondary channel signal, where the pitch period index value of the secondary channel signal is used to generate a to-be-sent stereo encoded bitstream.

In some embodiments of this application, the determining module includes: a primary channel encoding module, configured to encode the primary channel signal of the current frame, to obtain the estimated pitch period value of the primary channel signal; an open-loop analysis module, configured to perform open-loop pitch period analysis on the secondary channel signal of the current frame, to obtain an estimated open-loop pitch period value of the secondary channel signal; and a threshold determining module, configured to: determine whether a difference between the estimated pitch period value of the primary channel signal and the estimated open-loop pitch period value of the secondary channel signal exceeds a preset secondary channel pitch period differential encoding threshold; and when the difference exceeds the secondary channel pitch period differential encoding threshold, determine to perform differential encoding; or when the difference does not exceed the secondary channel pitch period differential encoding threshold, determine to skip performing differential encoding.

In some embodiments of this application, the stereo encoding apparatus further includes a flag configuration module, configured to: when it is determined to perform differential encoding on the pitch period of the secondary channel signal, configure a secondary channel pitch period differential encoding flag in the current frame to a preset first value, where the stereo encoded bitstream carries the secondary channel pitch period differential encoding flag, and the first value is used to indicate to perform differential encoding on the pitch period of the secondary channel signal.

In some embodiments of this application, the stereo encoding apparatus further includes an independent encoding module.

The independent encoding module is configured to: when it is determined to skip performing differential encoding on the pitch period of the secondary channel signal and skip reusing the estimated pitch period value of the primary channel signal as the pitch period of the secondary channel signal, separately encode the pitch period of the secondary channel signal and a pitch period of the primary channel signal.

Further, in some embodiments of this application, the flag configuration module is further configured to: when it is determined to skip performing differential encoding on the pitch period of the secondary channel signal, configure the secondary channel pitch period differential encoding flag to a preset second value, where the stereo encoded bitstream carries the secondary channel pitch period differential encoding flag, and the second value is used to indicate not to perform differential encoding on the pitch period of the secondary channel signal; and when it is determined to skip reusing the estimated pitch period value of the primary channel signal as the pitch period of the secondary channel signal, configure a secondary channel signal pitch period reuse flag to a preset third value, where the stereo encoded bitstream carries the secondary channel signal pitch period reuse flag, and the third value is used to indicate not to reuse the estimated pitch period value of the primary channel signal as the pitch period of the secondary channel signal.

The independent encoding module is configured to separately encode the pitch period of the secondary channel signal and the pitch period of the primary channel signal.

In some embodiments of this application, the flag configuration module is configured to: when it is determined to skip performing differential encoding on the pitch period of the secondary channel signal and reuse the estimated pitch period value of the primary channel signal as the pitch period of the secondary channel signal, configure the secondary channel signal pitch period reuse flag to a preset fourth value, and use the stereo encoded bitstream to carry the secondary channel signal pitch period reuse flag, where the fourth value is used to indicate to reuse the estimated pitch period value of the primary channel signal as the pitch period of the secondary channel signal.

Further, in some embodiments of this application, the flag configuration module is further configured to: when it is determined to skip performing differential encoding on the pitch period of the secondary channel signal, configure the secondary channel pitch period differential encoding flag to a preset second value, where the stereo encoded bitstream carries the secondary channel pitch period differential encoding flag, and the second value is used to indicate not to perform differential encoding on the pitch period of the secondary channel signal; and when it is determined to reuse the estimated pitch period value of the primary channel signal as the pitch period of the secondary channel signal, configure the secondary channel signal pitch period reuse flag to a preset fourth value, and use the stereo encoded bitstream to carry the secondary channel signal pitch period reuse flag, and the fourth value is used to indicate to reuse the estimated pitch period value of the primary channel signal as the pitch period of the secondary channel signal.

In some embodiments of this application, the differential encoding module includes: a closed-loop pitch period search module, configured to perform secondary channel signal closed-loop pitch period search based on the estimated pitch period value of the primary channel signal, to obtain an estimated pitch period value of the secondary channel signal; an index value upper limit determining module, configured to determine an upper limit of the pitch period index value of the secondary channel signal based on a pitch period search range adjustment factor of the secondary channel signal; and an index value calculation module, configured to calculate the pitch period index value of the secondary channel signal based on the estimated pitch period value of the primary channel signal, the estimated pitch period value of the secondary channel signal, and the upper limit of the pitch period index value of the secondary channel signal.

In some embodiments of this application, the closed-loop pitch period search module is configured to: determine a closed-loop pitch period reference value of the secondary channel signal based on the estimated pitch period value of the primary channel signal and a quantity of subframes into which the secondary channel signal of the current frame is divided; and perform closed-loop pitch period search by using integer precision and fractional precision and by using the closed-loop pitch period reference value of the secondary channel signal as a start point of the secondary channel signal closed-loop pitch period search, to obtain the estimated pitch period value of the secondary channel signal.

In some embodiments of this application, the closed-loop pitch period search module is configured to: determine a closed-loop pitch period integer part loc_T0 of the secondary channel signal and a closed-loop pitch period fractional part loc_frac_prim of the secondary channel signal based on the estimated pitch period value of the primary channel signal; and calculate the closed-loop pitch period reference value f_pitch_prim of the secondary channel signal in the following manner:

f_pitch_prim=loc_T0+loc_frac_prim/N;

where N represents the quantity of subframes into which the secondary channel signal is divided.

In some embodiments of this application, the index value upper limit determining module is configured to calculate the upper limit soft_reuse_index_high_limit of the pitch period index value of the secondary channel signal in the following manner:

soft_reuse_index_high_limit=0.5+2^{Z};

where Z is the pitch period search range adjustment factor of the secondary channel signal, and a value of Z is 3, 4, or 5.

In some embodiments of this application, the index value calculation module is configured to: determine a closed-loop pitch period integer part loc_T0 of the secondary channel signal and a closed-loop pitch period fractional part loc_frac_prim of the secondary channel signal based on the estimated pitch period value of the primary channel signal; and calculate the pitch period index value soft_reuse_index of the secondary channel signal in the following manner:

soft_reuse_index=(N*pitch_soft_reuse+pitch_frac_soft_reuse)−(N*loc_T0+loc_frac_prim)+soft_reuse_index_high_limit/M;

where pitch_soft_reuse represents an integer part of the estimated pitch period value of the secondary channel signal, pitch_frac_soft_reuse represents a fractional part of the estimated pitch period value of the secondary channel signal, soft_reuse_index_high_limit represents the upper limit of the pitch period index value of the secondary channel signal, N represents a quantity of subframes into which the secondary channel signal is divided, M represents an adjustment factor of the upper limit of the pitch period index value of the secondary channel signal, M is a non-zero real number, * represents a multiplication operator, + represents an addition operator, and − represents a subtraction operator.

In some embodiments of this application, the stereo encoding apparatus is applied to a stereo encoding scenario in which an encoding rate of the current frame is lower than a preset rate threshold.

The rate threshold is at least one of the following values: 13.2 kilobits per second kbps, 16.4 kbps, or 24.4 kbps.

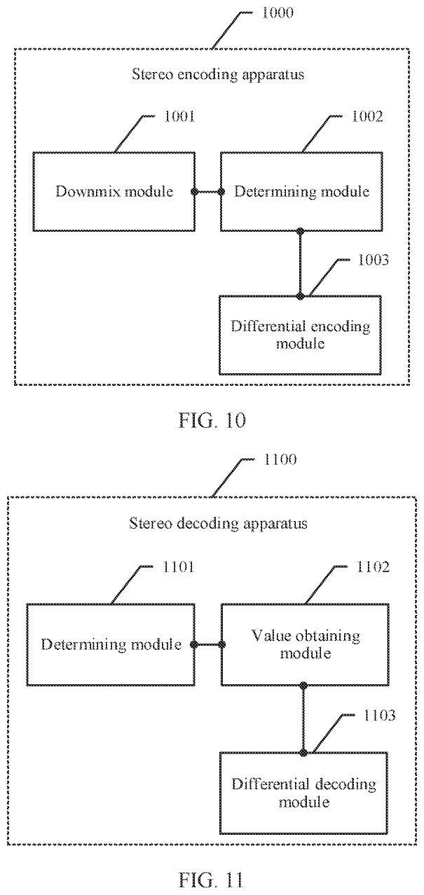

As shown in FIG. 11, a stereo decoding apparatus 1100 provided in an embodiment of this application may include a determining module 1101, a value obtaining module 1102, and a differential decoding module 1103.

The determining module 1101 is configured to determine, based on a received stereo encoded bitstream, whether to perform differential decoding on a pitch period of a secondary channel signal.

The value obtaining module 1102 is configured to: when it is determined to perform differential decoding on the pitch period of the secondary channel signal, obtain, from the stereo encoded bitstream, an estimated pitch period value of a primary channel signal of a current frame and a pitch period index value of the secondary channel signal of the current frame.

The differential decoding module 1103 is configured to perform differential decoding on the pitch period of the secondary channel signal based on the estimated pitch period value of the primary channel signal and the pitch period index value of the secondary channel signal, to obtain an estimated pitch period value of the secondary channel signal, where the estimated pitch period value of the secondary channel signal is used to decode the stereo encoded bitstream.

In some embodiments of this application, the determining module is configured to: obtain a secondary channel pitch period differential encoding flag from the current frame; and when the secondary channel pitch period differential encoding flag is a preset first value, determine to perform differential decoding on the pitch period of the secondary channel signal.

In some embodiments of this application, the stereo decoding apparatus further includes an independent decoding module.

The independent decoding module is configured to: when it is determined to skip performing differential decoding on the pitch period of the secondary channel signal and skip reusing the estimated pitch period value of the primary channel signal as the pitch period of the secondary channel signal, decode the pitch period of the secondary channel signal from the stereo encoded bitstream.

Further, the independent decoding module is configured to: when the secondary channel pitch period differential encoding flag is a preset second value, and a secondary channel signal pitch period reuse flag carried in the stereo encoded bitstream is a preset third value, determine not to perform differential decoding on the pitch period of the secondary channel signal, and not to reuse the estimated pitch period value of the primary channel signal as the pitch period of the secondary channel signal, and decode the pitch period of the secondary channel signal from the stereo encoded bitstream.

In some embodiments of this application, the stereo decoding apparatus further includes a pitch period reusing module.

The pitch period reusing module is configured to: when it is determined to skip performing differential decoding on the pitch period of the secondary channel signal and reuse the estimated pitch period value of the primary channel signal as the pitch period of the secondary channel signal, use the estimated pitch period value of the primary channel signal as the pitch period of the secondary channel signal.

Further, the pitch period reusing module is configured to: when the secondary channel pitch period differential encoding flag is the preset second value, and the secondary channel signal pitch period reuse flag carried in the stereo encoded bitstream is a preset fourth value, determine not to perform differential decoding on the pitch period of the secondary channel signal, and use the estimated pitch period value of the primary channel signal as the pitch period of the secondary channel signal.

In some embodiments of this application, the differential decoding module includes: a reference value determining submodule, configured to determine a closed-loop pitch period reference value of the secondary channel signal based on the estimated pitch period value of the primary channel signal and a quantity of subframes into which the secondary channel signal of the current frame is divided; an index value upper limit determining submodule, configured to determine an upper limit of the pitch period index value of the secondary channel signal based on a pitch period search range adjustment factor of the secondary channel signal; and an estimated value calculation submodule, configured to calculate the estimated pitch period value of the secondary channel signal based on the closed-loop pitch period reference value of the secondary channel signal, the pitch period index value of the secondary channel, and the upper limit of the pitch period index value of the secondary channel signal.

In some embodiments of this application, the estimated value calculation submodule is configured to calculate the estimated pitch period value T0_pitch of the secondary channel signal in the following manner:

T0_pitch=f_pitch_prim+(soft_reuse_index−soft_reuse_index_high_limit/M)/N;

where f_pitch_prim represents the closed-loop pitch period reference value of the secondary channel signal, soft_reuse_index represents the pitch period index value of the secondary channel signal, N represents the quantity of subframes into which the secondary channel signal is divided, M represents an adjustment factor of the upper limit of the pitch period index value of the secondary channel signal, M is a non-zero real number, / represents a division operator, + represents an addition operator, and − represents a subtraction operator.

According to the description of the examples of the foregoing embodiment, in this embodiment of this application, because differential encoding is performed on the pitch period of the secondary channel signal by using the estimated pitch period value of the primary channel signal, a small quantity of bit resources are required to be allocated to the pitch period of the secondary channel signal for differential encoding. Through differential encoding of the pitch period of the secondary channel signal, a sense of space and sound image stability of the stereo signal can be improved. In addition, in this embodiment of this application, a relatively small quantity of bit resources are used to perform differential encoding on the pitch period of the secondary channel signal. Therefore, saved bit resources may be used for other stereo encoding parameters, so that encoding efficiency of the secondary channel is improved, and finally overall stereo encoding quality is improved. In addition, in this embodiment of this application, when differential decoding can be performed on the pitch period of the secondary channel signal, the estimated pitch period value of the primary channel signal and the pitch period index value of the secondary channel signal may be used to perform differential decoding on the pitch period of the secondary channel signal, to obtain the estimated pitch period value of the secondary channel signal, and the stereo encoded bitstream may be decoded by using the estimated pitch period value of the secondary channel signal. Therefore, a sense of space and sound image stability of the stereo signal can be improved.

It should be noted that content such as information exchange between the modules/units of the apparatus and the execution processes thereof is based on the same idea as the method embodiments of this application, and therefore brings the same technical effects as the method embodiments of this application. For the specific content, refer to the foregoing descriptions in the method embodiments of this application. The details are not described herein again.

An embodiment of this application further provides a computer storage medium. The computer storage medium stores a program. The program is executed to perform some or all of the steps set forth in the foregoing method embodiments.

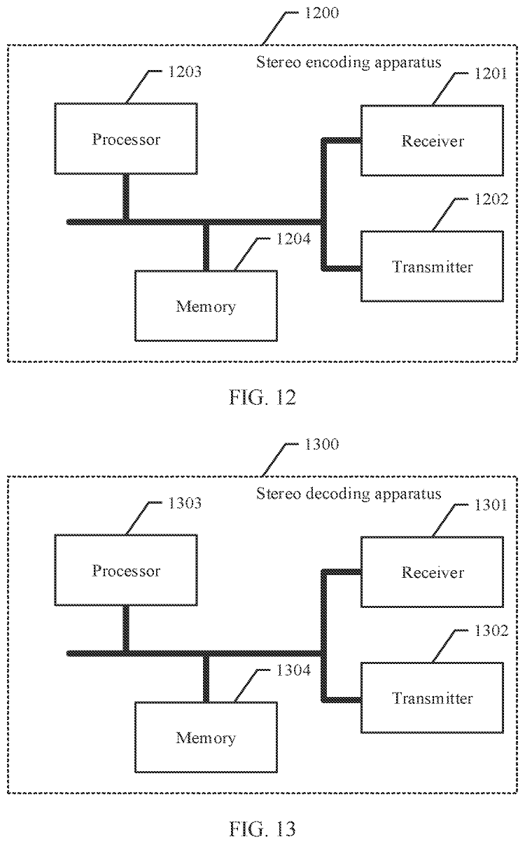

The following describes another stereo encoding apparatus provided in an embodiment of this application. As shown in FIG. 12, the stereo encoding apparatus 1200 includes: a receiver 1201, a transmitter 1202, a processor 1203, and a memory 1204 (there may be one or more processors 1203 in the stereo encoding apparatus 1200, and one processor is used as an example in FIG. 12). In some embodiments of this application, the receiver 1201, the transmitter 1202, the processor 1203, and the memory 1204 may be connected through a bus or in another manner. In FIG. 12, connection through a bus is used as an example.

The memory 1204 may include a read-only memory and a random access memory, and provide an instruction and data for the processor 1203. A part of the memory 1204 may further include a non-volatile random access memory (NVRAM). The memory 1204 stores an operating system and an operation instruction, an executable module or a data structure, a subset thereof, or an extended set thereof. The operation instruction may include various operation instructions to implement various operations. The operating system may include various system programs for implementing various basic services and processing hardware-based tasks.

The processor 1203 controls operations of the stereo encoding apparatus, and the processor 1203 may also be referred to as a central processing unit (CPU). In a specific application, components of the stereo encoding apparatus are coupled together by using a bus system. In addition to a data bus, the bus system includes a power bus, a control bus, a status signal bus, and the like. However, for clear description, various buses in the figure are referred to as the bus system.

The methods disclosed in the embodiments of this application may be applied to the processor 1203 or implemented by the processor 1203. The processor 1203 may be an integrated circuit chip and has a signal processing capability. In an implementation process, the steps in the foregoing methods may be completed by using a hardware integrated logic circuit in the processor 1203 or instructions in a form of software. The processor 1203 may be a general-purpose processor, a digital signal processor (DSP), an application-specific integrated circuit (ASIC), a field-programmable gate array (FPGA) or another programmable logic device, a discrete gate or a transistor logic device, or a discrete hardware component. The processor may implement or perform the methods, the steps, and logical block diagrams that are disclosed in the embodiments of this application. The general-purpose processor may be a microprocessor, or the processor may be any conventional processor, or the like. Steps of the methods disclosed with reference to the embodiments of this application may be directly performed and completed by a hardware decoding processor, or may be performed and completed by using a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in the memory 1204, and the processor 1203 reads information in the memory 1204 and completes the steps in the foregoing methods in combination with hardware of the processor.

The receiver 1201 may be configured to: receive input digital or character information, and generate a signal input related to a related setting and function control of the stereo encoding apparatus. The transmitter 1202 may include a display device such as a display screen, and the transmitter 1202 may be configured to output digital or character information by using an external interface.

In this embodiment of this application, the processor 1203 is configured to perform the stereo encoding method performed by the stereo encoding apparatus shown in FIG. 4 in the foregoing embodiment.

The following describes another stereo decoding apparatus provided in an embodiment of this application. As shown in FIG. 13, the stereo decoding apparatus 1300 includes: a receiver 1301, a transmitter 1302, a processor 1303, and a memory 1304 (there may be one or more processors 1303 in the stereo decoding apparatus 1300, and one processor is used as an example in FIG. 13). In some embodiments of this application, the receiver 1301, the transmitter 1302, the processor 1303, and the memory 1304 may be connected through a bus or in another manner. In FIG. 13, connection through a bus is used as an example.

The memory 1304 may include a read-only memory and a random access memory, and provide an instruction and data to the processor 1303. A part of the memory 1304 may further include an NVRAM. The memory 1304 stores an operating system and an operation instruction, an executable module or a data structure, a subset thereof, or an extended set thereof. The operation instruction may include various operation instructions to implement various operations. The operating system may include various system programs for implementing various basic services and processing hardware-based tasks.

The processor 1303 controls operations of the stereo decoding apparatus, and the processor 1303 may also be referred to as a CPU. In a specific application, components of the stereo decoding apparatus are coupled together by using a bus system. In addition to a data bus, the bus system includes a power bus, a control bus, a status signal bus, and the like. However, for clear description, various buses in the figure are referred to as the bus system.

The method disclosed in the foregoing embodiments of this application may be applied to the processor 1303, or may be implemented by the processor 1303. The processor 1303 may be an integrated circuit chip and has a signal processing capability. In an implementation process, steps in the foregoing methods can be implemented by using a hardware integrated logical circuit in the processor 1303, or by using instructions in a form of software. The foregoing processor 1303 may be a general-purpose processor, a DSP, an ASIC, an FPGA or another programmable logical device, a discrete gate or transistor logic device, or a discrete hardware component. The processor may implement or perform the methods, the steps, and logical block diagrams that are disclosed in the embodiments of this application. The general-purpose processor may be a microprocessor, or the processor may be any conventional processor, or the like. Steps of the methods disclosed with reference to the embodiments of this application may be directly performed and completed by a hardware decoding processor, or may be performed and completed by using a combination of hardware and software modules in the decoding processor. The software module may be located in a mature storage medium in the art, for example, a random access memory, a flash memory, a read-only memory, a programmable read-only memory, an electrically erasable programmable memory, or a register. The storage medium is located in the memory 1304, and the processor 1303 reads information in the memory 1304 and completes the steps in the foregoing methods in combination with hardware of the processor.

In this embodiment of this application, the processor 1303 is configured to perform the stereo decoding method performed by the stereo decoding apparatus shown in FIG. 4 in the foregoing embodiment.

In another possible design, when the stereo encoding apparatus or the stereo decoding apparatus is a chip in a terminal, the chip includes a processing unit and a communications unit. The processing unit may be, for example, a processor. The communications unit may be, for example, an input/output interface, a pin, or a circuit. The processing unit may execute a computer-executable instruction stored in a storage unit, to enable the chip in the terminal to execute the stereo encoding method according to any implementation of the foregoing first aspect. Optionally, the storage unit is a storage unit in the chip, for example, a register or a buffer; or the storage unit may be alternatively a storage unit outside the chip and in the terminal, for example, a read-only memory (ROM), another type of static storage device that can store static information and an instruction, or a random-access memory (RAM).

The processor mentioned above may be a general-purpose central processing unit, a microprocessor, an ASIC, or one or more integrated circuits for controlling program execution of the method according to the first aspect or the second aspect.

In addition, it should be noted that the described apparatus embodiment is merely an example. The units described as separate parts may or may not be physically separate, and parts displayed as units may or may not be physical units, that is, may be located in one place, or may be distributed on a plurality of network units. Some or all the modules may be selected according to an actual need to achieve the objectives of the solutions of the embodiments. In addition, in the accompanying drawings of the apparatus embodiments provided by this application, connection relationships between modules indicate that the modules have communication connections with each other, which may be specifically implemented as one or more communications buses or signal cables.

Based on the description of the foregoing implementations, a person skilled in the art may clearly understand that this application may be implemented by using software in combination with necessary universal hardware, or certainly, may be implemented by using dedicated hardware, including a dedicated integrated circuit, a dedicated CPU, a dedicated memory, a dedicated component, or the like. Generally, any function that can be completed by using a computer program can be very easily implemented by using corresponding hardware. Moreover, a specific hardware structure used to implement a same function may be in various forms, for example, in a form of an analog circuit, a digital circuit, a dedicated circuit, or the like. However, as for this application, software program implementation is a better implementation in most cases. Based on such an understanding, the technical solutions of this application essentially or the part contributing to the conventional technology may be implemented in a form of a software product. The computer software product is stored in a readable storage medium, such as a floppy disk, a universal serial bus (USB) flash drive, a removable hard disk, a ROM, a RAM, a magnetic disk, or an optical disc of a computer, and includes several instructions for instructing a computer device (which may be a personal computer, a server, a network device, or the like) to perform the methods described in the embodiments of this application.

All or some of the foregoing embodiments may be implemented by using software, hardware, firmware, or any combination thereof. When software is used to implement the embodiments, all or some of the embodiments may be implemented in a form of a computer program product.

The computer program product includes one or more computer instructions. When the computer program instructions are loaded and executed on a computer, the procedure or functions according to the embodiments of this application are all or partially generated. The computer may be a general-purpose computer, a dedicated computer, a computer network, or another programmable apparatus. The computer instructions may be stored in a computer-readable storage medium or may be transmitted from a computer-readable storage medium to another computer-readable storage medium. For example, the computer instructions may be transmitted from a website, a computer, a server, or a data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, such as a server or a data center, integrating one or more usable media. The usable medium may be a magnetic medium (for example, a floppy disk, a hard disk, or a magnetic tape), an optical medium (for example, a DVD), a semiconductor medium (for example, a solid-state drive (also referred to as a solid state disk, (SSD))), or the like.

What is claimed is:

1. A stereo encoding method, comprising:
performing downmix processing on a left channel signal of a current frame and a right channel signal of the current frame to obtain a primary channel signal of the current frame and a secondary channel signal of the current frame;
determining whether to perform differential encoding on a first pitch period of the secondary channel signal; and
performing, when determining to perform the differential encoding, the differential encoding using a first estimated pitch period value of the primary channel signal to obtain a pitch period index value of the secondary channel signal,
wherein the pitch period index value is for generating a to-be-sent stereo encoded bitstream.

2. The stereo encoding method of claim 1, further comprising:
encoding the primary channel signal of the current frame to obtain the first estimated pitch period value;
performing open-loop pitch period analysis on the secondary channel signal to obtain an estimated open-loop pitch period value of the secondary channel signal;
determining whether a difference between the first estimated pitch period value and the estimated open-loop pitch period value exceeds a preset secondary channel pitch period differential encoding threshold;
determining to perform the differential encoding when the difference exceeds the preset secondary channel pitch period differential encoding threshold; or
determining not to perform the differential encoding when the difference does not exceed the preset secondary channel pitch period differential encoding threshold.

3. The stereo encoding method of claim 1, further comprising:
determining whether to reuse the first estimated pitch period value as the first pitch period;
configuring, when determining to perform the differential encoding, a secondary channel pitch period differential encoding flag in the current frame to a preset first value, wherein the to-be-sent stereo encoded bitstream carries the secondary channel pitch period differential encoding flag, and wherein the preset first value indicates to perform the differential encoding;
separately encoding the first pitch period and a second pitch period of the primary channel signal when determining not to perform the differential encoding and not to reuse the first estimated pitch period value as the first pitch period; or
when determining not to perform the differential encoding and to reuse the first estimated pitch period value as the first pitch period:
configuring a secondary channel signal pitch period reuse flag to a preset fourth value, wherein the preset fourth value indicates to reuse the first estimated pitch period value as the first pitch period; and
using the to-be-sent stereo encoded bitstream to carry the secondary channel signal pitch period reuse flag.

4. The stereo encoding method of claim 1, wherein performing the differential encoding comprises:
performing a secondary channel signal closed-loop pitch period search based on the first estimated pitch period value to obtain a second estimated pitch period value of the secondary channel signal;
determining an upper limit of the pitch period index value based on a pitch period search range adjustment factor of the secondary channel signal; and
calculating the pitch period index value based on the first estimated pitch period value, the second estimated pitch period value, and the upper limit.

5. The stereo encoding method of claim 4, wherein performing the secondary channel signal closed-loop pitch period search comprises:
determining a closed-loop pitch period reference value of the secondary channel signal based on the first estimated pitch period value and a quantity of subframes into which the secondary channel signal of the current frame is divided; and
performing the secondary channel signal closed-loop pitch period search using integer precision and fractional precision and using the closed-loop pitch period reference value as a start point of the secondary channel signal closed-loop pitch period search to obtain the second estimated pitch period value.

6. The stereo encoding method of claim 5, wherein determining the closed-loop pitch period reference value comprises:
determining a closed-loop pitch period integer part loc_T0 of the secondary channel signal and a closed-loop pitch period fractional part loc_frac_prim of the secondary channel signal based on the first estimated pitch period value; and
calculating the closed-loop pitch period reference value based on the following equation:
f_pitch_prim=loc_T0+loc_frac_prim/N,
wherein N represents the quantity of subframes into which the secondary channel signal is divided, and wherein f_pitch_prim represents the closed-loop pitch period reference value.

7. The stereo encoding method of claim 4, wherein determining the upper limit comprises calculating the upper limit based on the following equation:
soft_reuse_index_high_limit=0.5+2^{Z},
wherein Z represents the pitch period search range adjustment factor, and wherein soft_reuse_index_high_limit represents the upper limit.

8. The stereo encoding method of claim 4, wherein calculating the pitch period index value comprises:
determining a closed-loop pitch period integer part loc_T0 of the secondary channel signal and a closed-loop pitch period fractional part loc_frac_prim of the secondary channel signal based on the first estimated pitch period value; and
calculating the pitch period index value based on the following equation:
soft_reuse_index=(N*pitch_soft_reuse+pitch_frac_soft_reuse)−(N*loc_T0+loc_frac_prim)+soft_reuse_index_high_limit/M,
wherein soft_reuse_index represents the pitch period index value, wherein pitch_soft_reuse represents an integer part of the second estimated pitch period value, wherein pitch_frac_soft_reuse represents a fractional part of the second estimated pitch period value, wherein soft_reuse_index_high_limit represents the upper limit, wherein N represents a quantity of subframes into which the secondary channel signal is divided, wherein M represents an adjustment factor of the upper limit, wherein M is a non-zero real number, wherein * represents a multiplication operator, wherein + represents an addition operator, and wherein − represents a subtraction operator.

9. A stereo encoding apparatus, comprising:
at least one processor; and
one or more memories coupled to the at least one processor and configured to store programming instructions that when executed by the at least one processor, cause the stereo encoding apparatus to:
perform downmix processing on a left channel signal of a current frame and a right channel signal of the current frame to obtain a primary channel signal of the current frame and a secondary channel signal of the current frame;
determine whether to perform differential encoding on a first pitch period of the secondary channel signal; and
perform, when determining to perform the differential encoding, the differential encoding using a first estimated pitch period value of the primary channel signal to obtain a pitch period index value of the secondary channel signal,
wherein the pitch period index value is for generating a to-be-sent stereo encoded bitstream.

10. The stereo encoding apparatus of claim 9, wherein when executed by the at least one processor, the programming instructions further cause the stereo encoding apparatus to:
encode the primary channel signal to obtain the first estimated pitch period value;
perform open-loop pitch period analysis on the secondary channel signal to obtain an estimated open-loop pitch period value of the secondary channel signal;
determine whether a difference between the first estimated pitch period value and the estimated open-loop pitch period value exceeds a preset secondary channel pitch period differential encoding threshold;
determine to perform the differential encoding when the difference exceeds the preset secondary channel pitch period differential encoding threshold; or
determine not to perform the differential encoding when the difference does not exceed the preset secondary channel pitch period differential encoding threshold.

11. The stereo encoding apparatus of claim 9, wherein when executed by the at least one processor, the programming instructions further cause the stereo encoding apparatus to:
determine whether to reuse the first estimated pitch period value as the first pitch period;
configure, when determining to perform the differential encoding on the first pitch period, a secondary channel pitch period differential encoding flag in the current frame to a preset first value, wherein the to-be-sent stereo encoded bitstream carries the secondary channel pitch period differential encoding flag, and wherein the preset first value indicates to perform the differential encoding;
separately encode the first pitch period and a second pitch period of the primary channel signal when determining not to perform the differential encoding and not to reuse the first estimated pitch period value as the first pitch period; and
when determining not to perform the differential encoding and to reuse the first estimated pitch period value as the first pitch period:
configure a secondary channel signal pitch period reuse flag to a preset fourth value, wherein the preset fourth value indicates to reuse the first estimated pitch period value as the first pitch period; and
use the to-be-sent stereo encoded bitstream to carry the secondary channel signal pitch period reuse flag.

12. The stereo encoding apparatus of claim 9, wherein when executed by the at least one processor, the programming instructions further cause the stereo encoding apparatus to:
perform a secondary channel signal closed-loop pitch period search based on the first estimated pitch period value to obtain a second estimated pitch period value of the secondary channel signal;
determine an upper limit of the pitch period index value based on a pitch period search range adjustment factor of the secondary channel signal; and
calculate the pitch period index value based on the first estimated pitch period value, the second estimated pitch period value, and the upper limit.

13. The stereo encoding apparatus of claim 12, wherein when executed by the at least one processor, the programming instructions further cause the stereo encoding apparatus to:
determine a closed-loop pitch period reference value of the secondary channel signal based on the first estimated pitch period value and a quantity of subframes into which the secondary channel signal is divided; and
perform the secondary channel signal closed-loop pitch period search using integer precision and fractional precision and using the closed-loop pitch period reference value as a start point of the secondary channel signal closed-loop pitch period search to obtain the second estimated pitch period value.

14. The stereo encoding apparatus of claim 13, wherein when executed by the at least one processor, the programming instructions further cause the stereo encoding apparatus to:
determine a closed-loop pitch period integer part loc_T0 of the secondary channel signal and a closed-loop pitch period fractional part loc_frac_prim of the secondary channel signal based on the first estimated pitch period value; and
calculate the closed-loop pitch period reference value based on the following equation:
f_pitch_prim=loc_T0+loc_frac_prim/N,
wherein f_pitch_prim represented the closed-loop pitch period reference value, and wherein N represents the quantity of subframes into which the secondary channel signal is divided.

15. The stereo encoding apparatus of claim 12, wherein when executed by the at least one processor, the programming instructions further cause the stereo encoding apparatus to:
calculate the upper limit based on the following equation:
soft_reuse_index_high_limit=0.5+2^{Z},
wherein soft_reuse_index_high_limit represents the upper limit, and wherein Z represents the pitch period search range adjustment factor.

16. The stereo encoding apparatus of claim 12, wherein when executed by the at least one processor, the programming instructions further cause the stereo encoding apparatus to:
determine a closed-loop pitch period integer part loc_T0 of the secondary channel signal and a closed-loop pitch period fractional part loc_frac_prim of the secondary channel signal based on the first estimated pitch period value; and
calculate the pitch period index value based on the following equation:
soft_reuse_index=(N*pitch_soft_reuse+pitch_frac_soft_reuse)−(N*loc_T0+loc_frac_prim)+soft_reuse_index_high_limit/M,
wherein soft_reuse_index represents the pitch period index value, wherein pitch_soft_reuse represents an integer part of the second estimated pitch period value, wherein pitch_frac_soft_reuse represents a fractional part of the second estimated pitch period value, wherein soft_reuse_index_high_limit represents the upper limit, wherein N represents a quantity of subframes into which the secondary channel signal is divided, wherein M represents an adjustment factor of the upper limit, wherein M is a non-zero real number, wherein * represents a multiplication operator, wherein + represents an addition operator, and wherein − represents a subtraction operator.

17. A computer program product comprising instructions that are stored on a computer-readable medium and that, when executed by a processor, cause an apparatus to:
perform downmix processing on a left channel signal of a current frame and a right channel signal of the current frame to obtain a primary channel signal of the current frame and a secondary channel signal of the current frame;
determine whether to perform differential encoding on a first pitch period of the secondary channel signal; and
perform, when determining to perform the differential encoding, the differential encoding using a first estimated pitch period value of the primary channel signal to obtain a pitch period index value of the secondary channel signal,
wherein the pitch period index value is for generating a to-be-sent stereo encoded bitstream.

18. The computer program product of claim 17, wherein when executed by the processor, the instructions further cause the apparatus to:
encode the primary channel signal of the current frame to obtain the first estimated pitch period value;
perform open-loop pitch period analysis on the secondary channel signal to obtain an estimated open-loop pitch period value of the secondary channel signal;
determine whether a difference between the first estimated pitch period value and the estimated open-loop pitch period value of the secondary channel signal exceeds a preset secondary channel pitch period differential encoding threshold;
determine to perform the differential encoding when the difference exceeds the preset secondary channel pitch period differential encoding threshold; or
determine not to perform the differential encoding when the difference does not exceed the preset secondary channel pitch period differential encoding threshold.

19. The computer program product of claim 17, wherein when executed by the processor, the instructions further cause the apparatus to:
determine whether to reuse the first estimated pitch period value as the first pitch period;
configure a secondary channel pitch period differential encoding flag in the current frame to a preset first value when determining to perform the differential encoding, wherein the to-be-sent stereo encoded bitstream carries the secondary channel pitch period differential encoding flag, and wherein the preset first value indicates to perform the differential encoding;
separately encode the first pitch period and a second pitch period of the primary channel signal when determining not to perform the differential encoding and not to reuse the first estimated pitch period value as the first pitch period; and
when determining not to perform the differential encoding and to reuse the first estimated pitch period value as the first pitch period:
configure a secondary channel signal pitch period reuse flag to a preset fourth value, wherein the preset fourth value indicates to reuse the first estimated pitch period value as the first pitch period; and
use the to-be-sent stereo encoded bitstream to carry the secondary channel signal pitch period reuse flag.

20. The computer program product of claim 17, wherein when executed by the processor, the instructions further cause the apparatus to:
perform a secondary channel signal closed-loop pitch period search based on the first estimated pitch period value to obtain a second estimated pitch period value of the secondary channel signal;
determine an upper limit of the pitch period index value based on a pitch period search range adjustment factor of the secondary channel signal; and
calculate the pitch period index value based on the first estimated pitch period value, the second estimated pitch period value, and the upper limit.
